(19) United States
(12) Patent Application Publication
(10) Pub. No.: US 2025/0323697 A1
(43) Pub. Date: Oct. 16, 2025

(54) METHOD AND NODE FOR DELAY MANAGEMENT IN COMMUNICATION SYSTEM

(71) Applicant: Samsung Electronics Co., Ltd., Suwon-si (KR)

(72) Inventors: Chunying TANG, Beijing (CN); Jianwei XU, Beijing (CN); Yunwei HUANG, Beijing (CN); Hyoseung KANG, Suwon-si (KR); Jaeyun KO, Suwon-si (KR); Keonwook LEE, Suwon-si (KR)

(21) Appl. No.: 19/249,363

(22) Filed: Jun. 25, 2025

Related U.S. Application Data
(63) Continuation of application No. PCT/KR2024/005877, filed on Apr. 30, 2024.

(30) Foreign Application Priority Data
Jun. 6, 2023 (CN) 202310665171.5
Jan. 26, 2024 (CN) 202410115536.1

(51) Int. Cl. H04B 7/06; H04B 17/364

(52) U.S. Cl. CPC H04B 7/0617; H04B 17/364

(57) ABSTRACT

Methods and nodes for delay management in a communication system are provided. A method performed by a first node in a communication system is provided. The method includes reporting a first delay parameter to a second node, wherein the first delay parameter is related to beamforming methods supported by the first node, receiving first configuration information related to delay management from the second node, and performing delay management based on the first configuration information.

### CROSS-REFERENCE TO RELATED APPLICATION(S)

This application is a continuation application, claiming priority under § 365(c), of an International application No. PCT/KR2024/005877, filed on Apr. 30, 2024, which is based on and claims the benefit of a Chinese patent application number 202310665171.5, filed on Jun. 6, 2023, in the Chinese Intellectual Property Office, and of a Chinese patent application number 202410115536.1, filed on Jan. 26, 2024, in the Chinese Intellectual Property Office, the disclosure of each of which is incorporated by reference herein in its entirety.

### TECHNICAL FIELD

The disclosure relates to the field of communications. More particularly, the disclosure relates to methods and nodes for delay management in a communication system (such as, but not limited to, a communication system based on an open radio access network (O-RAN)).

### BACKGROUND

The evolution of a core network of a communication system (for example, a 5^{th}-Generation (5G) system) is taking place. Because a radio access network (for example, a 5G radio access network) has the characteristics of multiple services, a large bandwidth and a high frequency band, it may cause decreased coverage of a single station, increased complexity of a device and increased scale of network construction, which lead to a huge network cost and an increased investment return risk. Considering the characteristics and requirements of the radio access network, it is necessary to introduce new R&D and design ideas of an information technology (IT), a communication technology (CT) and a data technology (DT) in the radio access network, which is in line with a macro evolution trend of the communication industry.

Based on this, operators are leading the creation of an open radio access network (O-RAN) industrial alliance, and put forward two core visions of “openness” and “intelligence”. This is in line with a development trend of the communication industry and is another major network reform led by the operators. The O-RAN alliance wants to use big data, machine learning (ML) and artificial intelligence (AI) technologies to build an open smart radio network, and meanwhile, combines open standards, white-box hardware and open source software to reduce the cost of the radio network.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and node for delay management in a communication system.

Additional aspects will be set forth in part in the description which follows and, in part, will be apparent from the description, or may be learned by practice of the presented embodiments.

In accordance with an aspect of the disclosure, a method performed by a first node in a communication system is provided. The method includes reporting a first delay parameter to a second node, wherein the first delay parameter is related to beamforming methods supported by the first node, receiving first configuration information related to delay management from the second node, and performing delay management based on the first configuration information.

In an implementation, the method further includes receiving third configuration information related to delay management from the second node and performing the delay management based on the third configuration information.

In at least one embodiment of the disclosure, the first delay parameter includes at least one delay profile, wherein each delay profile corresponds to one or more of beamforming methods supported by the first node.

The method provided according to at least one embodiment of the disclosure further includes reporting at least one second delay parameter, wherein the at least one second delay parameter corresponds to all beamforming methods supported by the first node.

In at least one embodiment of the disclosure, the first configuration information is determined based on the first delay parameter.

In at least one embodiment of the disclosure, the first configuration information includes information related to the beamforming methods.

The method provided according to at least one embodiment of the disclosure further includes transmitting second configuration information related to the delay parameters used by the first node to the second node, wherein the second configuration information includes information related to the beamforming methods updated based on the first configuration information.

In at least one embodiment of the disclosure, the first configuration information is configured by at least one of a user-plane config profile, a beamforming management profile and a delay management profile of a management plane.

In at least one embodiment of the disclosure, the second configuration information includes information related to a preset beamforming method or a not updated beamforming method of the first node.

The method provided according to at least one embodiment of the disclosure further includes transmitting indication information indicating that the first node supports dynamic configuration of delay parameters based on time units to the second node.

In at least one embodiment of the disclosure, the first node is an O-RAN radio unit (O-RU) and the second node is an O-RAN distributed unit (O-DU). As an example, a digital unit (DU) may be included in an O-RAN distributed unit (O-DU) (or distributed unit (DU)), depending on the distributed deployment implementation of a base station.

In an implementation, the first delay parameter comprises information of at least one delay profile, wherein each delay profile corresponds to one or more of the beamforming methods supported by the first node or no beamforming method, or the information of the delay profile comprises information about the beamforming methods corresponding to the delay profile or relevant information indicating that the delay profile does not correspond to a beamforming method.

In an implementation, the first delay parameter includes information of a delay profile supported by at least one endpoint of the first node, wherein the delay profile supported by the endpoint is associated with one or more beamforming methods supported by the endpoint or no beamforming method.

In an implementation, the information of the delay profile includes a delay profile identification (id).

In an implementation, the first delay parameter includes information of a delay profile obtained based on delay parameters of the plurality of beamforming methods corresponding to the first node.

In an implementation, the first configuration information includes information of the delay profile of at least one endpoint of the first node.

In an implementation, the information of the delay profile of the at least one endpoint of the first node includes the delay profile ID corresponding to the at least one endpoint.

In an implementation, in a case that the first configuration information does not include the information of the delay profile, the first node performs delay management according to a preset delay profile.

In an implementation, the method further includes transmitting information related to the beamforming methods to the second node, wherein the information includes at least one of computing resource consumption of the first node, channel quality, and a maximum number of data streams of the first node.

In an implementation, the method further includes receiving a first message related to updating of the delay profile from the second node, wherein the first message comprises transmitting slot information of the first message, time interval information and the information of the delay profile, determining time for switching the delay profile based on the transmitting slot information and the time interval information, and upon reaching the determined time for switching the delay profile, updating the delay profile of the corresponding endpoint based on the information of the delay profile.

In an implementation, a receive window of the first node becomes smaller after the delay profile is updated or a data processing delay of the first node changes after the delay profile is updated.

In an implementation, the first message is a control-plane message.

In an implementation, the method further includes transmitting, by the first node, maximum delay profile switching time information to the second node, wherein the time interval information is determined based on the maximum delay profile switching time.

In an implementation, the information of the delay profile includes the delay profile ID of the corresponding endpoint or the delay parameter corresponding to the delay profile of the corresponding endpoint.

In an implementation, the method further includes before updating the delay profile of the corresponding endpoint, transmitting to the second node a message indicating that it is ready to handle the updating of the delay profile.

In an implementation, the method further includes receiving a second message related to updating of the delay profile from the second node, wherein the second message includes information of the updated delay profile of at least one endpoint, and updating the delay profile of the corresponding endpoint based on the second message.

In an implementation, the receive window of the first node becomes larger after the delay profile is updated.

In an implementation, the second message is a management-plane message.

In accordance with another aspect of the disclosure, a method performed by a second node in a communication system is provided. The method includes receiving a first delay parameter from a first node, wherein the first delay parameter is related to beamforming methods supported by the first node and transmitting first configuration information related to delay management to the first node.

In at least one embodiment of the disclosure, the first delay parameter includes at least one delay profile, wherein each delay profile corresponds to one or more of beamforming methods supported by the first node.

The method provided according to at least one embodiment of the disclosure further includes receiving at least one second delay parameter from the first node, wherein the at least one second delay parameter corresponds to all beamforming methods supported by the first node.

In at least one embodiment of the disclosure, the first configuration information is determined by the second node based on the first delay parameter.

In at least one embodiment of the disclosure, the first configuration information includes information related to the beamforming methods.

The method provided according to at least one embodiment of the disclosure further includes receiving second configuration information related to the delay parameters used by the first node from the first node, wherein the second configuration information includes information related to the beamforming methods updated by the first node based on the first configuration information.

In at least one embodiment of the disclosure, the first configuration information is configured by at least one of a user-plane profile, a beamforming management profile and a delay management profile of a management plane.

In at least one embodiment of the disclosure, the second configuration information includes information related to a default beamforming method or a not updated beamforming method of the first node.

The method provided according to at least one embodiment of the disclosure further includes receiving indication information indicating that the first node supports dynamic configuration of delay parameters based on time units from the first node.

In at least one embodiment of the disclosure, the performing delay management based on the second configuration information includes according to the indication information, indicating delay parameters corresponding to time units to the first node based on the time units through a control-plane message.

In at least one embodiment of the disclosure, the first node is an O-RU and the second node is an O-DU.

In an implementation, the first delay parameter includes information of at least one delay profile, wherein each delay profile corresponds to one or more of the beamforming methods supported by the first node or no beamforming method, or the information of the delay profile includes information about the beamforming methods corresponding to the delay profile or relevant information indicating that the delay profile does not correspond to a beamforming method.

In an implementation, the first delay parameter includes information of a delay profile supported by at least one endpoint of the first node, wherein the delay profile supported by the endpoint is associated with one or more beamforming methods supported by the endpoint or no beamforming method.

In an implementation, the information of the delay profile includes a delay profile identification (ID).

In an implementation, the first delay parameter includes information of a delay profile obtained based on delay parameters of the plurality of beamforming methods corresponding to the first node.

In an implementation, the first configuration information includes information of the delay profile of at least one endpoint of the first node.

In an implementation, the information of the delay profile of the at least one endpoint of the first node includes the delay profile ID corresponding to the at least one endpoint.

In an implementation, the method further includes receiving information related to the beamforming methods from the first node, wherein the information includes at least one of computing resource consumption of the first node, channel quality, and a maximum number of data streams of the first node.

In an implementation, the method further includes transmitting a first message related to updating of a delay profile to the first node, wherein the first message includes transmitting slot information of the first message, time interval information and information of the delay profile.

In an implementation, before transmitting a first message related to updating of a delay profile to the first node, the method further includes determining that a receive window of the first node becomes smaller after the delay profile is updated or a data processing delay of the first node changes after the delay profile is updated.

In an implementation, the first message is a control-plane message.

In an implementation, the method further includes receiving maximum delay profile switching time information from the first node, and determining the time interval information based on the maximum delay profile switching time.

In an implementation, the information of the delay profile includes the delay profile ID of the corresponding endpoint or the delay parameter corresponding to the delay profile of the corresponding endpoint.

In an implementation, the method further includes receiving, from the first node, a message indicating that it is ready to handle the updating of the delay profile.

In an implementation, the method further includes transmitting a second message related to updating of the delay profile to the first node, wherein the second message includes information of the updated delay profile of at least one endpoint.

In an implementation, before transmitting a second message related to updating of a delay profile to the first node, the method further includes determining that the receive window of the first node becomes larger after the delay profile is updated.

In an implementation, the second message is a management-plane message.

In accordance with another aspect of the disclosure, a method performed by a first node in a communication system is provided. The method includes reporting a third delay parameter to the second node, wherein the third delay parameter corresponds to all beamforming methods supported by the first node and performing delay management using the third delay parameter.

In accordance with another aspect of the disclosure, a method performed by a second node in a communication system is provided. The method includes receiving a third delay parameter from the first node, wherein the third delay parameter corresponds to all beamforming methods supported by the first node, and performing delay management using the third delay parameter.

In accordance with another aspect of the disclosure, a method performed by a first node in a communication system is provided. The method includes reporting a first delay parameter to a second node, wherein the first delay parameter is related to beamforming methods supported by the first node, receiving first configuration information related to delay management from the second node, and performing delay management based on the first configuration information.

In accordance with another aspect of the disclosure, a first node in a communication system is provided. The first node includes a transceiver configured to transmit and/or receive signals, memory storing one or more computer programs, and one or more processors communicatively coupled to the transceiver and the memory wherein the one or more computer programs include computer-executable instructions that, when executed by the one or more processors, cause the first node to report a first delay parameter to a second node, wherein the first delay parameter is related to beamforming methods supported by the second node, receive first configuration information related to delay management from the second node, and perform delay management based on the first configuration information.

In accordance with another aspect of the disclosure, a second node in a communication system is provided. The second node includes a transceiver configured to transmit and/or receive signals, memory storing one or more computer programs, and one or more processors communicatively coupled to the transceiver and the memory wherein the one or more computer programs include computer-executable instructions that, when executed by the one or more processors, cause the second node to report a first delay parameter to the second node, wherein the first delay parameter is related to beamforming methods supported by the second node, receive first configuration information related to delay management from the second node, and perform delay management based on the first configuration information.

In accordance with another aspect of the disclosure, one or more non-transitory computer-readable storage media storing computer-executable instructions that, when executed by one or more processors of a first node, cause the first node to perform operations are provided. The operations include reporting a first delay parameter to a second node, wherein the first delay parameter is related to beamforming methods supported by the first node, receiving first configuration information related to delay management from the second node, and performing delay management based on the first configuration information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an overall architecture of an O-RAN based communication system according to an embodiment of the disclosure;

FIGS. 2A and 2B illustrate a schematic diagram of an example of a flow of delay management (based on newly added parameters) according to various embodiment of the disclosure;

FIG. 3 illustrates a schematic diagram of an example of a management flow of dynamic updating of delay management (a management flow based on dynamic management of a delay profile) according to an embodiment of the disclosure;

FIG. 4 illustrates a schematic diagram of an example of a management flow of delay management according to an embodiment of the disclosure;

FIG. 5 illustrates a schematic diagram of a simplified hardware structure of a first node according to an embodiment of the disclosure;

FIG. 6 illustrates a schematic diagram of a simplified hardware structure of a second node according to an embodiment of the disclosure;

FIG. 7 illustrates a schematic diagram related to a calculation of a transmit window and a receive window between an O-DU and an O-RU according to an embodiment of the disclosure;

FIG. 8 illustrates a schematic diagram of a delay management process in an O-RAN according to an embodiment of the disclosure;

FIG. 9 illustrates a schematic diagram illustrating that an O-RU reports delay configurations of different beamforming methods supported by each endpoint according to an embodiment of the disclosure;

FIG. 10 illustrates a schematic diagram illustrating that an O-DU configures a single delay profile used by each endpoint to the O-RU according to an embodiment of the disclosure;

FIG. 11 illustrates a schematic diagram of a reconfiguration method for reconfiguring a delay profile to an O-RU by the O-DU according to an embodiment of the disclosure; and

FIG. 12 illustrates a schematic diagram of a reconfiguration method for reconfiguring a delay profile to an O-RU by the O-DU according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not be limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents . . .

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed (or digital) unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜ module’, ‘˜ unit’, ‘˜ part’, ‘˜ body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

Before proceeding with the description of the specific embodiments below, it may be advantageous to set forth definitions of certain words and phrases used throughout this patent document. The term “coupled” and its derivatives refer to any direct or indirect communication between two or more elements, regardless of whether these elements are in physical contact with each other. The terms “transmitting”, “receiving” and “communicating” and their derivatives cover direct and indirect communication. The terms “comprising” and “including” and their derivatives mean including but not limited to. The term “or” is inclusive and means “and/or”. The phrase “associated with” and its derivatives mean “comprising”, “comprised in”, “connected to”, “interconnected with”, “including”, “included in”, “connected to” or “connected with”, “coupled to” or “coupled with”, “communicated with”, “cooperated with”, “interwoven with”, “co-located”, “close to”, “bound to” or “bound with”, “having”, “having properties of”, “having a relation with”, “related to”, or the like. The term “controller” means any device, system or part thereof that controls at least one operation. Such a controller may be implemented in hardware or in a combination of hardware and software and/or firmware. Functions associated with any particular controller may be centralized or distributed locally or remotely. The phrase “at least one of . . . ” when used with a list of items means that different combinations of one or more of listed items may be used, and it is possible that only one item in the list is needed. For example, “at least one of A, B and C” includes any one of the following combinations: A, B, C, A and B, A and C, B and C, and A and B and C. For example, “at least one of A, B or C” includes any of the following combinations: A, B, C, A and B, A and C, B and C, and A and B and C.

Furthermore, various functions described below may be implemented or supported by one or more computer programs, each more computer program formed by a computer readable program code and embodied in a computer readable medium. The terms “application” and “program” refer to one or more computer programs, software components, instruction sets, processes, functions, objects, classes, examples, related data or parts thereof suitable for implementation in suitable computer readable program codes. The phrase “computer readable program code” includes any type of computer code, including a source code, an object code and an executable code. The phrase “computer readable medium” includes any type of medium that can be accessed by a computer, such as read-only memory (ROM), random access memory (RAM), a hard disk drive, a compact disk (CD), a digital versatile disk (DVD) or any other type of memories. A “non-transitory” computer readable medium excludes wired, wireless, optical or other communication links that transmit transient electrical or other signals. The non-transitory computer readable medium includes a medium that can store data permanently and a medium that can store and rewrite data later, such as a rewritable optical disk or erasable memory device.

The terms used herein to describe embodiments of the disclosure are not intended to limit and/or define the scope of the disclosure. For example, unless otherwise defined, technical or scientific terms used in the disclosure should have their ordinary meanings as understood by one of ordinary skill in the art to which the disclosure belongs.

It should be understood that “first”, “second”, and the like, as used in the disclosure, do not denote any order, quantity, or importance, but rather are used to distinguish one element from another.

As used herein, any reference to “one example” or “an example”, “one embodiment” or “an embodiment” means that a particular element, feature, structure or characteristic described in connection with the embodiment is included in at least one embodiment. The phrases “in one embodiment” or “in one example” that appear in different parts of the specification do not necessarily refer to the same embodiment.

As used herein, “a part of” a thing means “at least some” of the thing, so it may mean less than all the thing or all the thing. Therefore, “a part of” a thing includes the whole thing as a special case, that is, an example in which the whole thing is a part of the thing.

As used herein, the term “set” means one or more. Therefore, the set of items may be a single item or a set of two or more items.

In the disclosure, to determine whether certain conditions are met, expressions, such as “greater than” or “less than” are used as examples, and expressions, such as “greater than or equal to” or “less than or equal to” are also applicable and are not excluded. For example, conditions defined by “greater than or equal to” may be replaced by “greater than” (or vice versa), and conditions defined by “less than or equal to” may be replaced by “less than” (or vice versa), and so on.

As will be further understood, the term “comprising” or “including” and the like mean that elements or articles mentioned before the word encompass elements or articles listed after the word and their equivalents, without excluding other elements or articles. “Connected” or “linked” and the like are not limited to physical or mechanical connection, but can include electrical connection, regardless of direct or indirect connection. “Upper”, “lower”, “left” and “right” are only used to indicate relative positional relationships, and when an absolute position of a described object changes, the relative positional relationships may also change accordingly.

The various embodiments discussed below for describing the principles of the disclosure in this patent document are for illustration only and should not be construed as limiting the scope of the disclosure in any way. Those skilled in the art will understand that the principles of the disclosure may be implemented in any suitably arranged wireless communication systems.

Here, depending on the type of a network, the term “base station” or “BS” may refer to any component (or a set of components) configured to provide radio access to the network, such as a transmission point (TP), a transmission and reception point (TRP), an enhanced base station (eNodeB or eNB), a 5G base station (gNB), a femtocell, a WiFi access point (AP) or other radio enabled devices. The base station can provide radio access according to one or more radio communication technologies, such as 5G 3GPP new radio (NR) interface/access, long term evolution (LTE), LTE advanced (LTE-A), high-speed packet access (HSPA), Wi-Fi 802.11a/b/g/n/ac, or the like. It can be understood by those skilled in the art that a “terminal” and a “terminal device” used herein include both a wireless signal receiver device, which has no transmission capability, and a hardware device for receiving and transmitting, which can perform bidirectional communication in a bidirectional communication link. Such a device may include a cellular or other communication device having a single-line display or a multi-line display or a cellular or other communication device without the multi-line display, a personal communication system (PCS), which can combine voice, data processing, fax and/or data communication capabilities, a personal digital assistant (PDA), which may include a radio frequency (RF) receiver, a pager, Internet/Intranet access, a web browser, a notepad, a calendar and/or a global positioning system (GPS) receiver, and a laptop and/or palmtop computer or other device of the related art having and/or including a radio frequency receiver. The “terminal” and “terminal device” as used herein may be portable, transportable, installed in vehicles (aeronautical, maritime, and/or land vehicles), or suitable and/or configured to operate locally, and/or operate in any other location on the earth and/or space in a distributed form. The “terminal” and “terminal device” as used herein can also be communication terminals, Internet terminals, music/video playing terminals, such as PDAs, mobile Internet devices (MID) and/or mobile phones with music/video playing functions, as well as televisions (TVs), set-top boxes and other devices.

In the disclosure, various embodiments will be described using terminologies adopted in some communication technologies, such as the third generation partnership project (3GPP) and open radio access network (O-RAN), but these embodiments are only for illustrative purposes. Through modification, the embodiments of the disclosure can also be easily applied to other communication systems.

Herein, unless otherwise specified, the terms “user”, “user equipment (UE)” and “terminal” can be used interchangeably. In addition, unless otherwise indicated, the terms “base station” and “cell” can be used interchangeably.

Herein, an E2 node may be one of a next generation node B (gNB), a distributed unit (DU), an evolved node B (eNB), a gNB control unit (gNB-CU), en-gNB and ng-eNB.

Some aspects of the disclosure relate to delay configuration management of a communication node (e.g., an O-RU). Next, the O-RU will be described as an example of a communication node for dynamic management of delay configuration. It can be understood that the principles of the technical solutions described in the disclosure can also be applied to other types of communication nodes that perform delay configuration management. In the description of the disclosure, operations performed for delay management between a first node and a second node are mainly described, wherein the first node is, for example, an O-RU and the second node is, for example, an O-DU.

Some or all of delay parameters related to an O-RU operation may be referred to as an O-RU delay profile. Since the delay characteristic of the O-RU may be different due to air interface attributes and beamforming methods, multiple groups of delay parameters are provided according to different combinations of one or more of a subcarrier spacing (SCS), a channel bandwidth and beamforming methods, and some or all of delay parameters in each group may be referred to as a delay profile.

In the description of the disclosure, descriptions, such as “delay parameter”, “delay profile” and “set of delay parameters” are used for the convenience of description. It can be understood that they are only examples of names of parameters used for delay management, to represent parameters, profiles or configuration information related to delay management. Therefore, it can be understood that other names can also be used to represent such parameters, profiles or configuration information, for example, “delay configuration”, “delay file”, “delay configuration parameter”, “delay configuration parameter set”, “delay configuration information”, “delay profile”, “delay distribution”, “delay spectrum”, or the like, which are all used to represent parameters for delay management that are relevant to the principles of the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

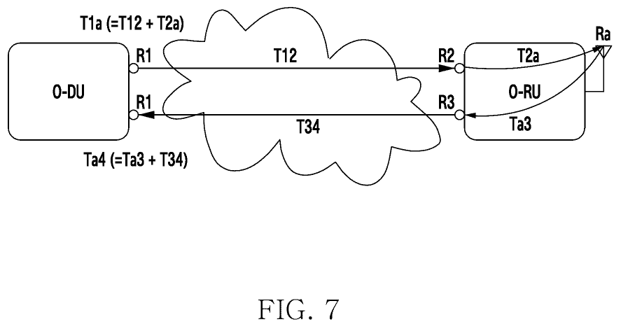

FIG. 7 illustrates a schematic diagram related to the calculation of a transmit window and a receive window between an O-DU and an O-RU according to an embodiment of the disclosure.

Referring to FIG. 7, the delay management is a key process to open a fronthaul interface (between the O-DU and the O-RU) in an ORAN architecture. The data stream between the O-DU and the O-RU includes a user plane, a control plane, a synchronization plane message flow, or the like. In order to ensure the correct transmission and reception of these messages, it is necessary to correctly calculate an appropriate transmit window and receive window by using delay parameters, as shown in FIG. 7:

Correct calculation of transmission/receive window Ttrasmit_recv_win=f (T12, T2a, Ta3, T34)

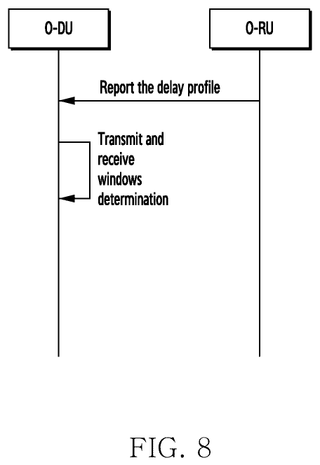

FIG. 8 illustrates a schematic diagram of a delay management process in an O-RAN according to an embodiment of the disclosure.

Referring to FIG. 7, a delay management process is shown in FIG. 8, which includes the following operations:
Operation 1: an O-RU reports delay parameters to an O-DU through a management plane, and when requested, all O-RUs transmit a table of static “predefined” values of the delay parameters through a management plane interface for different supported combinations of subcarriers and channel bandwidths.
Operation 2: transmit and receive windows in the O-DU are determined, where when calculating the transmit and receive windows of the O-DU in a timing domain, the O-DU uses delay configuration parameters suitable for each O-RU according to attributes of an air interface used by the O-RU in the specific network configuration.

For example, examples of delay parameters (or referred to as interface parameters) reported by the O-RU are as follows:

TABLE 1
module: o-ran-delay-management
+--rw delay-management
+--rw bandwidth-scs-delay-state* [bandwidth subcarrier-spacing]

| \| | +--rw bandwidth | uint32 |
|---|---|---|
| \| | +--rw subcarrier-spacing | uint32 |
| \| | +--ro ru-delay-profile | |
| \| | +--ro t2a-min-up | uint32 |
| \| | +--ro t2a-max-up | uint32 |
| \| | +--ro t2a-min-cp-dl | uint32 |
| \| | +--ro t2a-max-cp-dl | uint32 |
| \| | +--ro tcp-adv-dl | uint32 |
| \| | +--ro ta3-min | uint32 |
| \| | +--ro ta3-max | uint32 |
| \| | +--ro t2a-min-cp-ul | uint32 |
| \| | +--ro t2a-max-cp-ul | uint32 |

The current delay management in the ORAN specification does not consider multiple beamforming methods supported by the O-RU, which may cause a communication delay (e.g., an ultra-reliable low-latency communication (URLLC) scenario failure), degradation of system performance (e.g., throughput degradation), and even a system and communication failure.

The current ORAN supports four beamforming (BF) methods, and different beamforming methods correspond to different BF weight calculation processes. For example, depending on whether the weight calculation is performed on an O-DU side or an O-RU side, there may be different BF weight calculation processes. If the weight calculation is carried out in the O-RU, the T2a (O-RU data processing delay) relevant parameters may be increased, further affecting the receive window of the O-RU. The current O-RAN technology only supports reporting a group of delay parameters, but endpoints may support different BF methods, which may lead to larger or smaller Ttrasmit_recv_win. A larger O-RU receive window means that more buffers are needed and more computing resources are occupied, which leads to the degradation of the system performance, such as throughput, while a smaller O-RU receive window may lead to a packet loss and retransmission, resulting in a longer communication delay and even a communication failure.

CU plane applications need to be uniquely associated with a specific data stream. This association is achieved by defining one O-RU “processing element”, and then the O-RU “processing element” may be associated with a specific control plane/user plane (C/U plane) endpoint address (where each O-RU may have multiple endpoints).

TABLE 2

| | BF1 weight is calculated | BF2 weight is calculated |
|---|---|---|
| Delay parameter | at the O-DU | at the O-RU |
| T2a_max_up | 345 us | 345 us |
| T2a_min_up | 134 us | 134 us |
| Tcp_adv_dl | 125 us | 475 us |
| T2a_max_cp_dl | 669 us | 820 us |
| T2a_min_cp_dl | 259 us | 609 us |
| Ta3_max | 171 us | 171 us |
| Ta3_min | 50 us | 50 us |
| T2a_max_cp_ul | 535 us | 336 us |
| T2a_min_cp_ul | 125 us | 125 us |

As shown in the table, if the O-RU reports a group of BF2-related delay configuration parameters, but an endpoint 1 works under BF1, this will result in a smaller O-RU receive window (820−609=211 us instead of 669−259=410 us); if the O-RU reports a group of BF1-related delay configuration parameters, but an endpoint 2 works under BF2, this will result in a larger O-RU receive window (669−259=410 us instead of 820−609=211 us). Therefore, if the O-RU is required to support simultaneous use of multiple BF methods, reporting a delay distribution without taking multiple BF methods into consideration will degrade performance.

According to at least one embodiment of the disclosure, there is provided a method and an apparatus for delay management by a fronthaul interface in a communication system according to a plurality of beamforming methods. The method includes: acquiring information related to delay management of an O-RU under different beamforming methods; selecting different beamforming methods for the O-RU in an O-DU; and feeding back, by the O-RU, a result of setting beamforming methods of the O-DU.

The method according to at least one embodiment of the disclosure may consider delay management under various beamforming methods supported by the O-RU. Since the delay profile of the O-RU may be different due to the different beamforming methods adopted by the O-RU, when requested, the O-RU may transmit a table of parameter values of the corresponding delay profiles for different beamforming methods supported by the management plane interface. Based on different beamforming methods, the O-RU may configure and use the delay profiles corresponding to the beamforming methods, so that the problem that the O-RU cannot support the use of different O-RU delay parameters under multiple beamforming methods is solved, and the effects of optimizing an O-RU buffer and increasing a utilization rate of O-DU resources are further achieved.

According to an aspect of the disclosure, a method for O-RU delay management in an O-RAN based communication system may include: acquiring, by a network function (e.g., an O-DU node), information related to delay management based on different beamforming methods supported by an O-RU through an interface between the network function (e.g., the O-DU node) and a function of the O-RU, where, for example, the O-DU may receive reported information, e.g., information reported by the O-RU; and issuing, by the O-DU, policy information through the corresponding interface. Information reporting may include reporting of information related to O-RU delay management. The policy information may indicate a change in the beamforming method.

According to an aspect of the disclosure, different delay management policies may include one of:
a method for performing delay management based on newly added management plane parameters;
a method for dynamically performing delay management based on time slots based on configuring a beamforming method by a control plane;
a delay management method based on interface invariance.

According to an aspect of the disclosure, the received reported information may include at least one of: delay parameters (or delay profiles) of the O-RU, for example, delay parameters of the O-RU corresponding to different beamforming methods; the beamforming method selected for use by the O-RU and/or the delay parameter corresponding to the beamforming method. For example, throughout the whole text, the delay parameter or delay profile reported by the O-RU to the O-DU may be referred to as, for example, a first delay parameter.

According to an aspect of the disclosure, configuring by the O-RU includes selecting a beamforming method to be used. The configured beamforming methods may be one beamforming method, or multiple beamforming methods are supported at the same time. The configuring beamforming methods include at least one of: updating configuration based on beamforming method parameters newly added at a management plane; updating configuration based on a remote procedure call interface model newly added at the management plane; and dynamically updating configuration based on beamforming methods at a control plane.

According to an aspect of the disclosure, different beamforming methods may include at least one of: a beamforming method with predefined beams; a dynamic beamforming method based on beam weights; a dynamic beamforming method based on beam characteristics; and a beamforming method based on channel state information.

Embodiments of the disclosure at least include the following contents:
1. The O-RU supports the reporting of multiple independent delay configuration parameters corresponding to different supported beamforming methods. Each group of delay configuration parameters may be associated with one or more beamforming methods, and may also be associated with no beamforming method (No BF).

A delay profile identification (for example, delay-profile-id) is used to identify delay configuration parameter combinations with same values. Each delay-profile-id may or may not be associated with one or more beamforming methods. For example, a mapping relationship between the delay-profile-id and the beamforming methods may be fixed. Furthermore, multiple beamforming methods may have same delay configuration parameters.

The capability of reporting delay configuration parameters for each endpoint. Current beamforming methods may be based on endpoints, and different endpoints may support different beamforming methods.
2. The O-DU may select a group of delay configuration parameters and notify the O-RU.

One endpoint may support multiple beamforming methods, but each endpoint may only use one delay configuration parameter. Otherwise, it is difficult for the O-RU to dynamically determine the delay configuration parameters to be applied, because a whole control-plane message needs to be parsed to know the beamforming method used.
3. The O-DU may dynamically update the beamforming methods and reconfigure the corresponding delay profiles.

The beamforming methods may change for reasons, such as energy saving. The O-DU may dynamically use different beamforming methods.
4. The O-DU may configure switching time for the O-RU to ensure synchronization of switching, without deactivating all carriers.

The current reconfiguration of the delay profiles needs to disable all carriers of the O-RU. In this case, frequent dynamic updates have a serious impact on O-RU services.

Throughout the whole text, the delay configuration parameters notified or transmitted by the O-DU to the O-RU may be referred to as, for example, first configuration information related to delay management.

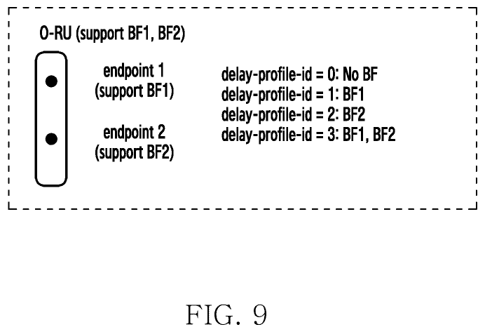

FIG. 9 a illustrates diagram illustrating that the O-RU reports delay configurations of different beamforming methods supported by each endpoint according to an embodiment of the disclosure.

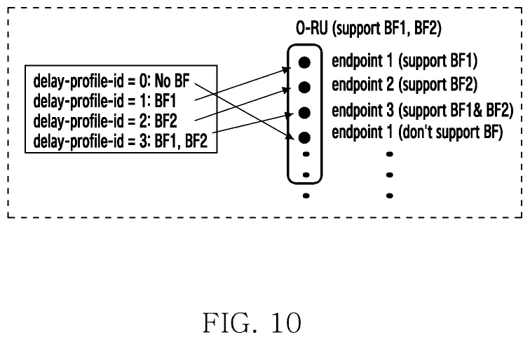

FIG. 10 illustrates a schematic diagram illustrating that the O-DU configures a single delay profile used by each endpoint to the O-RU according to an embodiment of the disclosure.

Referring to FIGS. 9 and 10, examples of solutions are as follows.
1. The O-RU reports delay configuration of different beamforming methods supported by each endpoint. For example, the first delay parameter includes information of a delay profile supported by at least one endpoint of the first node, as shown in FIG. 9. For example, the O-RU may report the corresponding delay profile identification (ID) for each endpoint.
2. The O-DU configures an individual delay profile used by each endpoint to the O-RU, as shown in FIG. 10.

For each endpoint, when the supported beamforming method is updated, the O-DU reconfigures the delay profile to the O-RU according to the updated beamforming method of the endpoint, and when reconfiguring the delay parameters, the options are as follows:
Option 1: deactivating a carrier or a related endpoint to set new delay configuration to the O-RU endpoint for synchronization.
Option 2: setting new delay configuration without deactivating the carrier, and keeping the synchronization between the O-RU and the O-DU through transmission delay time and maximum delay switching time.

According to the method of the embodiment of the disclosure, the second node (e.g., the O-DU) may perform delay management on the first node according to the beamforming methods supported by the first node (e.g., the O-RU), so that a delay setting between the first node and the second node can better adapt to a current communication environment or communication situation, further improving the communication efficiency. Furthermore, according to the method provided by the embodiment of the disclosure, the second node may use simple signaling to configure appropriate (e.g., optimal) delay configuration parameters for the first node according to an actual situation of the first node, and dynamically configure updated delay configuration parameters for the first node when the actual situation changes (e.g., when a situation related to using the beamforming method changes). Furthermore, according to the method of the embodiment of the disclosure, the first node and the second node can update the delay configuration parameters synchronously. In addition, according to the embodiment of the disclosure, the second node may also update the delay configuration parameters in a synchronous or asynchronous manner according to the actual situation of updating the delay configuration parameters for the first node.

Next, an example embodiment of the disclosure will be described with reference to the accompanying drawings.

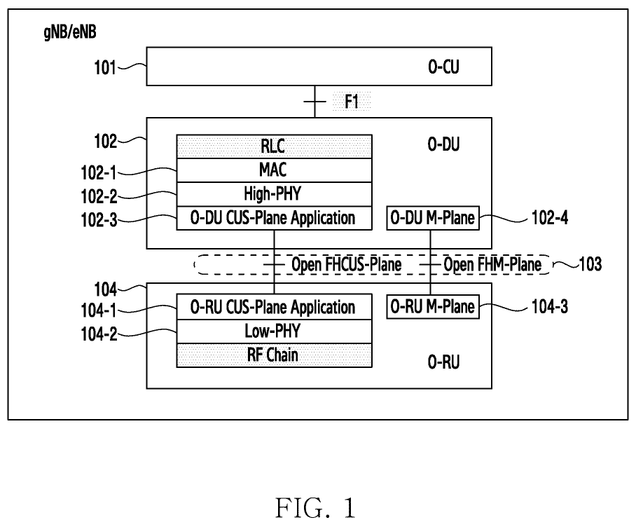

FIG. 1 illustrates an overall architecture of an O-RAN based communication system according to an embodiment of the disclosure.

Referring to FIG. 1, the overall architecture of the O-RAN based communication system is based on a centralized unit (CU)/distributed unit (DU) architecture and functional virtualization of a radio access network (for example, a base station), the reference design of an open interface and open hardware is introduced, and meanwhile a radio control flow is optimized by using artificial intelligence.

A reference architecture of a base station in the O-RAN is shown in FIG. 1. The base station in the figure may be a next generation NodeB (gNB), namely, an new radio (NR) base station supporting 5G NR or an evolved NodeB (eNB), namely a long term evolution (LTE) base station supporting 4G LTE. Reference architectures of the gNB and the eNB are slightly different, but they have no influence on the contents of the disclosure, so that it is not distinguished between gNB and the eNB. Functional entities other than the base station in the O-RAN and their interfaces with the base station are not involved in the disclosure and are therefore not shown in the figure. The following will briefly introduce some components of the reference architecture of the base station in the O-RAN shown in FIG. 1:

O-RAN central unit (O-CU) 101: a logical node including an O-RAN centralized unit control plane (O-CU-CP) and an O-RAN centralized unit user plane (O-CU-UP), where the O-CU-CP is a logical node including radio resource control (RRC) and a packet data convergence protocol (PDCP) control plane, and the O-CU-UP is a logical node including a PDCP user plane and an service data adaptation protocol (SDAP).

O-RAN Distributed Unit (O-DU) 102: a logical node including radio link control (RLC), media access control (MAC), high physical layer (High-PHY) and unique functions in the O-RAN.

MAC 102-1: a 3GPP functional layer, which is responsible for multiplexing MAC service data units (SDUs) from one or more different logical channels into a transport block (TB) and transmitting the TB to a physical layer through a transport channel, and demultiplexing the TB submitted from the physical layer from the transmission channel into the MAC SDUs of the one or more different logical channels, and which has other functions, such as error correction through an hybrid automatic repeat request (HARQ). It is also a logical functional entity on one gNB/eNB, called a scheduler, which dynamically allocates time and frequency resources for uplink and downlink air interfaces.

High-PHY 102-2: a function of processing in the O-DU after the physical layer of the 3GPP functional layer is split, which is responsible for encoding/decoding, channel estimation, modulation/demodulation, scrambling/descrambling and other functions.

O-DU control, user, synchronization plane application (O-DU CUS-plane application), abbreviated as an O-DU application in the disclosure 102-3: an O-DU logical function, which is responsible for creating and transmitting messages of a control-plane (C-plane), a user-plane (U-plane) and an synchronization-plane (S-plane) to the O-RAN radio unit (O-RU) or receiving and processing the messages from the O-RU on the fronthaul interface. The control-plane message carries relevant information (such as scheduling and beamforming instructions) for controlling the user-plane message, the user-plane message carries time-frequency domain In-phase/quadrature (I/Q) data, and the synchronization-plane message is used to achieve time-frequency synchronization between the O-DU and the O-RU.

O-DU management plane (O-DU M-Plane) 102-4: an O-DU logical function, which is based on network configuration/yet another next generation (NETCONF/YANG) to perform initialization, software management, configuration management, performance management, fault management, file management and the like on the O-RU.

O-RAN open fronthaul interface (OFH I/F) 103: includes CUS-plane and M-plane interfaces, which may be interfaces based on an enhanced common public radio interface (eCPRI) or an institute of electrical and electronics engineers (IEEE) 1914.3, with the contents transmitted on the interface following the O-RAN CUS-Plane and M-Plane.

O-RAN radio unit (O-RU) 104: a gNB/eNB physical node in the O-RAN, including low physical layer (Low-PHY) and an RF Chain (radio frequency link).

O-RU control, user, synchronization plane application (O-RU CUS-plane application), abbreviated as an O-RU application in the disclosure 104-1: an O-RU logical function, which is responsible for creating and transmitting messages of the C-Plane, the U-Plane and the S-Plane to the O-DU or receiving and processing the messages from the O-DU on the fronthaul interface.

Low-PHY 104-2: a function of processing in the O-RU after the physical layer of the 3GPP functional layer is split, which is responsible for fast Fourier transform/invert fast Fourier transformation (FFT/IFFT), analog beamforming, digital beamforming, digital-to-analog/analog-to-digital conversion and other functions.

O-RU management plane (O-RU M-Plane) 104-3: an O-RU logical function, which accepts the management of the O-DU M-Plane, and reports the capabilities to the O-DU in an initialization stage to notify the O-DU which optional capabilities the O-RU supports.

Currently, safe, synchronous, low-energy-consumption O-RU deployments are being considered. In a current situation, the O-RU only supports one delay configuration. This is because the delay parameters between the O-DU and the O-RU are important parameters to define the transmit and/or receive buffer windows and optimize a buffering operation at a receive end.

O-RAN delay management only supports one group of delay configurations for different BF methods of each O-RU. The delay management operations are as follows:
1. The O-RU reports delay configuration to the O-DU through a management plane.
2. The O-DU determines transmit and receive windows, and when calculating the transmit and receive windows of the O-DU, the delay profile suitable for each O-RU is used.

In such a way that the O-RU only supports one delay configuration, the O-RU cannot select different delay configurations according to different beamforming methods. Based on an intuitive solution, when the O-RU supports multiple BF methods and the BF methods can be changed frequently, the O-RU reports one delay configuration according to a worst case considering the multiple BF methods.

For example, the O-RU supports BF1 and BF2, where an endpoint 1 supports BF1 and an endpoint 2 supports BF2. Worst-case delay configuration is reported for the calculation of the transmit and receive windows. For the endpoint 1: the O-RU receive window is calculated according to a worst case of the two BFs, and a length of the O-RU receive window is equal to T2a_max_cp_dl-T2a_min_cp_dl. For example, the length of the O-RU receive window is 1035−609=426 us in the worst case instead of 820−609=211 us required when only BF1 is supported. This causes the set receive window of O-RU to be larger than an actual requirement, thus requiring more buffers and more computing resources, which will lead to the need for more buffers and the degradation of the system performance, a too long cache window of a network device (for example, the O-RU), the waste of O-RU buffers, an increase of a processing load of the O-DU due to delay requirements, and the inability of the O-DU to effectively schedule resources, further reducing the performance of the communication system. For example, in general, the delay parameter tcp-adv-dl (value 475 us) in a beamforming method based on channel state information is greater than tcp-adv-dl (value 125 us) in a real-time beamforming method. Therefore, the O-DU needs to transmit the control-plane message for beamforming based on channel state information earlier. Thus, the O-DU also needs to generate the control-plane message earlier to meet the requirements of downlink tcp-adv-dl, which will hinder efficient resource scheduling of the O-DU and lead to the degradation of system performance, such as the degradation of throughput.

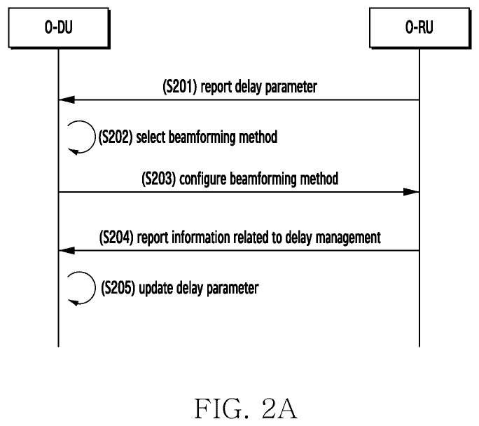

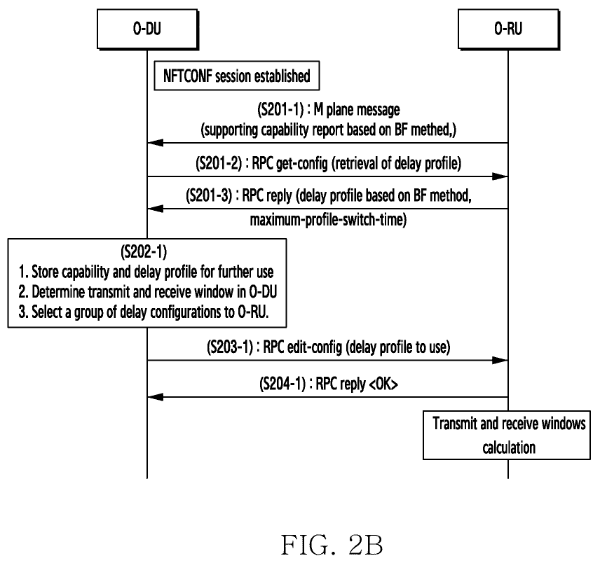

In order to address at least the above issues, some aspects of the disclosure provide an improved method for determining O-RU delay management. For example,
1. When the O-RU of the disclosure supports multiple BF methods, the O-RU may report its capability of supporting multiple delay profiles based on the BF methods, such as reporting the first delay parameter to the first node. Since the BF methods are based on multiple endpoints in the O-RU, the delay configuration parameters may be managed per endpoint. The multiple BF methods may have same delay parameters. Each group of delay parameters (also referred to as each delay profile) may be associated with one or more BF methods, or with No BF method (No BF);
2. The O-DU in some aspects of the disclosure may comprehensively analyze an optimal beamforming method that the communication system should use at present, so as to notify the O-RU of using information (for example, a delay profile) related to the optimal beamforming method. For example, the second node transmits first configuration information related to delay management to the first node. Compared with the way that the O-RU supporting different beamforming methods only has one delay profile, some embodiments of the disclosure can make full use of the capability of the O-RU of supporting different beamforming methods, and correspondingly perform delay management with full coverage of the delay configuration, so that the performances of the O-RU and the O-DU are improved. A schematic diagram of an example of a management flow (based on a management plane) for determining O-RU delay management is described below with reference to FIG. 2.
3. In order to dynamically change the BF method used during an operation, the O-DU may update the selected delay configuration accordingly. The O-DU may dynamically update the BF method and reconfigure the corresponding delay configuration. For example, the beamforming methods may change for reasons, such as energy saving. The O-DU may dynamically use different BF methods. And, the O-DU may configure switching time for the O-RU (for example, delay profile switching time or BF method switching time), so as to ensure synchronization of switching without affecting current services of the O-RU.

FIGS. 2A and 2B illustrate a schematic diagram of an example of a flow of delay management (based on newly added parameters) according to an embodiment of the disclosure. The method described in connection with FIG. 2 is only an example, and some operations may be omitted or some new operations may be added.

Referring to FIG. 2A, in operation S201, the O-RU reports first information (including delay parameters) related to delay management. For example, the first information may also be referred to as the first delay parameter. For example, the O-RU may support one beamforming method or multiple different beamforming methods, and can report delay profiles corresponding to different beamforming methods, and the delay profile may include at least one delay parameter supported by the O-RU corresponding to the beamforming method. For example, the O-RU transmits first information related to delay management in uplink through a management-plane O-FH interface between the O-RU and the O-DU. For example, the first information includes: supported beamforming methods, for example, one or more of a beamforming method based on channel state information, a beamforming method with predefined beams, a dynamic beamforming method based on beam weights, a dynamic beamforming method based on beam characteristics, or the like. In an implementation, the information may further include an O-RU delay profile corresponding to the beamforming method.

Referring to FIG. 2B, delay management between the O-RU and the O-DU may include operations S201-1, S201-2, S201-3, S202-1, S203-1 and S204-1. For example, through operations S201-1 to S201-3, the O-RU reports the delay parameters based on the BF method to the O-DU through a management-plane message, and the message transmitted by the O-RU to the O-DU in operation S201-3 may include maximum window switching time (or referred to as maximum profile switching time) supported by the O-RU.

If the O-RU supports multiple beamforming methods, the O-RU may use delay-profile-id to transmit respective values of the parameters corresponding to the delay profiles for different supported beamforming methods.

Each delay-profile-id associates one or more BF methods or no-BF method with a set of delay parameters (or a delay profile), and a mapping relationship between delay-profile-id and the beamforming methods may be fixed.

In an initial start-up stage, the O-RU may notify supported delay configuration per static endpoint in an endpoint type (using a delay profile ID) in a capability report.

In operation S202-1, the O-DU may perform some operations related to the configuration of the transmit/receive window, as exemplified in operation S202-1 in FIG. 2B. In operation S203-1, the O-DU may notify the O-RU of the configured delay configuration. In operation S204-1, the O-RU may reply to the O-DU. For example, the reported delay profile includes but not limited to at least one of the following delay parameters: 12a-min-up, t2a-max-up, t2a-min-cp-dl, t2a-max-cp-dl, tcp-adv-dl, ta3-min, ta3-max, t2a-min-cp-ul, t2a-max-cp-ul.

When considering a downlink data direction, these parameters include:
T2a_min: corresponding to a minimum O-RU data processing delay between the reception of a last data sample through a fronthaul interface and the transmission of a first IQ sample at an antenna.
T2a_max: corresponding to earliest allowable time of receiving the data packet before the corresponding first IQ sample is transmitted at the antenna.
Using the above parameters (T2a_max−T2a_min): a difference between the two parameters corresponds to a range of an O-RU receive window.
T2a_min_cp_dl: corresponding to a minimum O-RU data processing delay between the reception of a downlink real-time control-plane message through the fronthaul interface and the transmission of the corresponding first IQ sample at the antenna.
T2a_max_cp_dl: corresponding to earliest allowable time of receiving the downlink real-time control message before the corresponding first IQ sample is transmitted at the antenna.
Tcp_adv_dl: corresponding to a time difference (advance) between a receive window of a downlink real-time control message and a receive window of a corresponding IQ data message.
Tda: corresponding to a time difference between the output of a DL signal at an antenna connector of the O-RU and the transmission in the air.

Delay parameters related to the O-RU operation in an uplink data direction include:
Ta3_min: corresponding to a minimum O-RU data processing delay between the reception of an IQ sample at the antenna and the transmission of the first data sample through the fronthaul interface.
Ta3_max: corresponding to a maximum O-RU data processing delay between the reception of an IQ sample at the antenna and the transmission of a last data sample through the fronthaul interface.

Using the above parameters (Ta3_max−Ta3_min): a difference between the two parameters corresponds to a range of an O-RU transmit window.
T2a_min_cp_ul: a minimum O-RU data processing delay between the reception of a real-time uplink control-plane message through the fronthaul interface and the reception of a first IQ sample at the antenna.
T2a_max_cp_ul: earliest allowable time of receiving a real-time uplink control message before the corresponding first IQ sample is received at the antenna.
Tau: corresponding to a time difference between the reception in the air and the input of a UL signal at the antenna connector of the O-RU.

The method for the O-RU to report the first information related to delay management may include at least one of the following methods.

Method 1: the delay profile may be reported in the o-ran-delay-management.yang file through the management plane, and by defining new parameters, multiple groups of delay profiles are reported according to the supported beamforming methods.

delay-profile-id is used to identify delay configuration combinations (or delay profiles) with the same values, and each delay profile may be related to one or more BF methods. For example, respective delay parameter values (e.g., respective BF methods) may be reported according to different BF methods. In order to report respective values according to different BF methods, one new parameter (for example, “delay-profile-id”) may be introduced to report the delay profile for each BF method. Since each delay-profile-id may be associated with one or more BF methods or no-BF method, the O-RU may report multiple delay profiles identified using “delay-profile-id”. For example, a mapping relationship between delay-profile-id and the BF methods may be fixed. If the O-RU wants to use the multiple BF methods at the same time, and their corresponding delay configurations are different, the O-RU may generate a delay configuration that may indicate the simultaneous use of the multiple BF methods.

To maintain backward compatibility, the BF method is an optional parameter. None of the BF methods being explicitly state to be supported may be regarded as supporting all existing BF methods.

```
module: o-ran-delay-management
  +--rw delay-management
    +-- bf-method-same-delay-profile* [delay-profile-id]
```

| | | |
|---|---|---|
| \| | +--ro delay-profile-id | uint16 |
| \| | +--ro beamforming-method* | enumeration |

+--rw bandwidth-scs-delay-state* [bandwidth subcarrier-spacing]

| \| | +--rw bandwidth | bandwidth |
|---|---|---|
| \| | +--rw subcarrier-spacing | uint32 |
| \| | +--ro ru-delay-profile-beamforming-method* | |
| | [delay-profile-id] | |
| \| | +--ro delay-profile-id | uint16 |
| \| | +--ro ru-delay-profile | |

For example, each O-RU has multiple endpoints, and different endpoints may support different BF methods. The O-RU may report four different delay profiles, as illustrated below:
delay-profile-id=0 indicates that there is no explicit correlation with any BF method;
delay-profile-id=1 or 2 indicates a corresponding value of a BF method;
delay-profile-id=3 indicates that BF1 and BF2 are used at the same time.

The O-RU may report the delay profiles supported by each endpoint, such as: endpoints 1-4: delay-profile-id=0 and 1; endpoints 5-8: delay-profile-id=0, 1, 2, 3; O-DU may only select the delay profile for each endpoint.

| module: o-ran-uplane-conf | | |
|---|---|---|
| +--rw user-plane-configuration | | |
| +--ro endpoint-types* [id] | | |
| \| | +--ro id | uint16 |
| \| | +--ro supported-delay-profile-id* | enumeration |

The new delay profile may be defined as ru-delay-profile-per-bfmethod of a list type, but it is not limited to this. A parameter beamforming-method is added to the new delay profile to indicate the beamforming method corresponding to the current delay profile, and the type of the parameter beamforming-method may be a list. If the delay profiles corresponding to multiple beamforming methods are the same, it is possible to report only one group of delay parameters (i.e., a set of delay parameters or a delay profile) for these beamforming methods. When the delay parameters supported by all the beamforming methods are the same or the ORU does not support beamforming, the parameter beamforming-method may be optional.

+--rw delay-management
+--rw bandwidth-scs-delay-state* [bandwidth subcarrier-spacing]

| \| | +--rw bandwidth | bandwidth |
|---|---|---|
| \| | +--rw subcarrier-spacing | uint32 |
| \| | +--ro ru-delay-profile-per-bfmethod* [id] | |
| \| | +--ro id | uint16 |
| \| | +--ro beamforming-method* | |
| \| | +--ro t2a-min-up | uint32 |
| \| | +--ro t2a-max-up | uint32 |
| \| | +--ro t2a-min-cp-dl | uint32 |
| \| | +--ro t2a-max-cp-dl | uint32 |
| \| | +--ro tcp-adv-dl | uint32 |
| \| | +--ro ta3-min | uint32 |
| \| | +--ro ta3-max | uint32 |
| \| | +--ro t2a-min-cp-ul | uint32 |
| \| | +--ro t2a-max-cp-ul | uint32 |

In an implementation, the O-RU may report the delay profile corresponding to each beamforming method it supports, and a node beamforming-method may be of an enumeration type, and each beamforming method corresponds to one delay profile (including a group of delay parameters). Examples are as follows:

+--rw delay-management
+--rw bandwidth-scs-delay-state* [bandwidth subcarrier-spacing]

| \| | +--rw bandwidth | bandwidth |
|---|---|---|
| \| | +--rw subcarrier-spacing | uint32 |
| \| | +--ro ru-delay-profile-per-bfmethod* [id] | |
| \| | +--ro id | uint16 |
| \| | +--ro beamforming-method? | Enumeration |
| \| | +--ro t2a-min-up | uint32 |
| \| | +--ro t2a-max-up | uint32 |
| \| | +--ro t2a-min-cp-dl | uint32 |
| \| | +--ro t2a-max-cp-dl | uint32 |
| \| | +--ro tcp-adv-dl | uint32 |
| \| | +--ro ta3-min | uint32 |
| \| | +--ro ta3-max | uint32 |
| \| | +--ro t2a-min-cp-ul | uint32 |
| \| | +--ro t2a-max-cp-ul | uint32 |

In an implementation, the table of delay parameters may be provided according to different combinations of one or more of an subcarrier spacing (SCS), a channel bandwidth, and a beamforming method, considering that the delay characteristic of the O-RU may vary depending on different combinations of one or more of the subcarrier spacing (SCS), the channel bandwidth, and the beamforming method. The O-RU may transmit a table of delay profile values for different combinations of one or more of supported subcarrier spacing, channel bandwidth and beamforming methods through a management plane interface, and the newly added parameter bandwidth-scs-bf-delay-state takes the parameter beamforming-method as one of the type “key” statements in bandwidth-SCS-bf-delay-state, and, together with the subcarrier spacing (SCS) and/or the channel bandwidth, serves as a combination value of the specified “key” to represent the newly added parameter.

+--rw delay-management

+--rw bandwidth-scs-bf-delay-state* [bandwidth subcarrier-spacing

beamforming-method]

| | \| | +--rw bandwidth | bandwidth |
|---|---|---|---|
| | \| | +--rw subcarrier-spacing | uint32 |
| \| | +--rw beamforming-method | | enumeration |
| | \| | +--ro ru-delay-profile | |
| | \| | +--ro t2a-min-up | uint32 |
| | \| | +--ro t2a-max-up | uint32 |
| | \| | +--ro t2a-min-cp-dl | uint32 |
| | \| | +--ro t2a-max-cp-dl | uint32 |
| | \| | +--ro tcp-adv-dl | uint32 |
| | \| | +--ro ta3-min | uint32 |
| | \| | +--ro ta3-max | uint32 |
| | \| | +--ro t2a-min-cp-ul | uint32 |
| | \| | +--ro t2a-max-cp-ul | uint32 |

Method 2: delay parameters may be reported in group according to their characteristics. For example, In an implementation, a part of delay parameters are unchanged under different beamforming methods, while the other part of delay parameters are different according to different beamforming methods. Delay parameters that are unchanged under different beamforming methods, such as t2a-min-up and t2a-max-up, are unchanged under the beamforming method based on channel state information and the dynamic beamforming method based on beam weights, then these delay parameters may be defined as a new group “ru-delay-profile” and reported only once. On the other hand, the delay parameter group changed according to different beamforming methods may be defined as a new “list” ru-delay-profile-per-bfmethod to declare, and “key” is added to the parameter to instantiate delay parameters under multiple different beamforming methods. Examples are as follows:

+--rw delay-management
+--rw bandwidth-scs-delay-state* [bandwidth subcarrier-spacing]

| \| | +--rw bandwidth | bandwidth |
|---|---|---|
| \| | +--rw subcarrier-spacing | uint32 |
| \| | +--ro ru-delay-profile | |
| \| | +--ro t2a-min-up | uint32 |
| \| | +--ro t2a-max-up | uint32 |
| \| | +--ro t2a-min-cp-dl | uint32 |
| \| | +--ro ta3-min | uint32 |
| \| | +--ro ta3-max | uint32 |
| \| | +--ro ru-delay-profile-per-bfmethod* [id] | |
| \| | +--ro id | uint16 |
| \| | +--ro beamforming-method* | |
| \| | +--ro t2a-max-cp-dl | uint32 |
| \| | +--ro tcp-adv-dl | uint32 |
| \| | +--ro t2a-min-cp-ul | uint32 |
| \| | +--ro t2a-max-cp-ul | uint32 |

In operation S202, the O-DU may select a beamforming method used for delay management, for example, the beamforming method to be configured to the O-RU, according to the reported delay profile, weight accuracy or O-RU capability. A selection process is implemented internally. For example, the O-DU may change the beamforming method and the delay profile for the method, such as at least one delay parameter corresponding to the beamforming method, according to the channel feedback information. In an implementation, the O-DU selects the beamforming method according to the delay profile reported by the O-RU in operation S201.

In operation S203, after the O-DU acquires the first information related to delay management of various beamforming methods supported by the O-RU, the O-DU may select the optimal beamforming method through certain policies and configure the one or more selected beamforming methods to the O-RU. The O-DU may configure the changed beamforming method to the O-RU through the O-FH interface.

Regarding the delay management between the O-RU and the O-DU:
1. When the O-RU indicates that it supports multiple delay profiles based on different beamforming methods, the O-DU may select a delay profile ID according to different use cases. New configuration parameters are added in a management-plane interface, and the O-DU configures delay-profile-id according to its supported beamforming method. Each endpoint may be configured with only one delay-profile-id.
2. When the delay-profile-id has been configured, the O-RU should use the values of various delay parameters corresponding to the delay-profile-id. If the O-DU does not configure any selected configuration ID to the O-RU, the O-RU will run according to a default delay profile value.

For example, each O-RU has multiple endpoints, and different endpoints may support different BF methods. Based on the processes of operations S201-1 to S201-3, the O-RU reports four different delay configuration parameters, such as:
delay-profile-id=0: No BF
delay-profile-id=1: BF 1
delay-profile-id=2: BF 2
delay-profile-id=3: BF1, BF2
where, delay-profile-id=0 indicates that there is no explicit correlation with any BF method;
delay-profile-id=1 or 2 indicates a corresponding value of a BF method;
delay-profile-id=3 indicates a corresponding delay profile when BF1 and BF2 are used at the same time. The O-RU may report the delay profiles supported by each endpoint, such as: endpoints 1-4: delay-profile-ID=0 and 1; endpoints 5-8: delay-profile-ID=0, 1, 2, 3.

At this time, the O-DU may be configured as follows according to different requirements:
1. The O-DU wants the O-RU to use a group of delay configurations:
the DU does not configure any delay profile id. At this time, the O-RU selects a default value, for example, delay-profile-ID=3;
2. Only one BF method (BF 1) is used during operation of the O-DU,
the O-DU configures delay-profile-id=1 for each endpoint for the O-RU. Each endpoint will use the delay parameters corresponding to delay-profile-id=1;
3. Both BF methods may be used during operation of the O-DU:
the O-DU configures two types of endpoints, and the O-DU sets delay-profile-id 1 for four of the endpoints: transmitting to these four endpoints using a message of beamforming 1.
the O-DU sets delay-profile-id 2 for the remaining four endpoints: transmitting to these four endpoints using a related message of beamforming 2.
the O-DU configures all endpoints to support delay-profile-id=3.

In an implementation, a configuration content of configuring a beamforming method includes one or more selected beamforming methods.

For example, in at least one embodiment of the disclosure, the beamforming method configuration is configured to the O-RU through a management-plane model.

The O-DU may configure the beamforming method by at least one of the following methods:

Method 1: new configuration parameters are added into o-ran-uplane-conf.yang, and the O-DU configures the delay-profile-id according to its supported beamforming methods. Each endpoint may be configured with only one delay-profile-id. Examples are as follows:

+--rw low-level-tx-endpoints* [name]

| | \| | +--rw name | −> /user-plane-configuration/static- |
|---|---|---|---|
| low-level-tx-endpoints/name | | | |
| | \| | +--rw sro-id? | −> /or-user:users/user/sro-id |

{feat:SHARED-O-RU-MULTI-OPERATOR}?

| \| | +--rw delay-profile-configuration* | |
|---|---|---|
| \| | \| | +--rw delay-profile-id |

Method 2: beamforming-type parameter beamforming-method-configuration may be newly added into the existing parameter “low-level-tx/rx-endpoints” in the o-ran-uplane-conf.yang file for configuration, where the beamforming-method-configuration parameter is a beamforming method selected for use by the O-DU, the type may be defined as a list, and the parameters in the list include one or more beamforming-methods, which are exemplified as follows:

+--rw low-level-tx-endpoints* [name]

| | | |
|---|---|---|
| \| | +--rw name | −> /user-plane-configuration/static- |

low-level-tx-endpoints/name

| | | |
|---|---|---|
| \| | +--rw sro-id? | −> /or-user:users/user/sro-id |

{feat:SHARED-O-RU-MULTI-OPERATOR}?

| \| | +--rw compression! | | Uint8 |
|---|---|---|---|
| \| | \| | +--rw iq-bitwidth? | compression-type-def |
| \| | \| | +--rw compression-type | Uint8 |
| \| | \| | x-rw bitwidth? | Compression-method- |

| | | |
|---|---|---|
| \| | \| | +--rw compression-method? |

def

| | | |
|---|---|---|
| \| | \| | x-rw (compression-format)? |

| \| | +--rw frame-structure? | Uint8 |
|---|---|---|
| \| | +--rw cp-type? | Enumeration |
| \| | +--rw cp-length | uint16 |
| \| | +--rw cp-length-other | uint16 |
| \| | +--rw offset-to-absolute-frequency-center | int32 |
| \| | +--rw number-of-prb-per-scs* [scs] | |
| \| | +--rw e-axcid | |
| \| | +--rw coupling-to? | |
| \| | +--rw coupling-method? | Enumeration |
| \| | +--rw configurable-tdd-pattern-supported? | |
| \| | +--rw cplane-message-processing-limits-enabled? | |
| \| | +--rw uplane-message-section-header-limit-enabled? | |
| \| | +--rw beam-update-contention-control-enabled? | |
| \| | +--rw | channel-information-prb-group-configuration |

{feat:CHANNEL-INFORMATION-PRB-GROUP}?

| | | |
|---|---|---|
| \| | +--rw non-scheduled-ueid-enabled? | Boolean {feat:NON- |

SCHEDULED-UEID}?

| | |
|---|---|
| \| | +--rw se-11-continuity-flag-enabled? |
| \| | +--rw combination-configuration |

| \| | +--rw beamforming-method-configuration* | |
|---|---|---|
| \| | \| | +--rw beamforming-method? |

Method 3: it may be implemented by configuring and newly adding a remote procedure call (rpc) model to the beamforming profile o-ran-beamforming.yang, and configuration is performed by an input parameter beamforming-method, and the O-DU configures beamforming-method to the O-RU. Examples are as follows:

```
  rpc:
    +---x activate-beamforming-config {MODIFY-BEAMFORMING-
CONFIG}?
```

| \| | +---w input | |
|---|---|---|
| \| | \| | +---w beamforming-method* |

| | |
|---|---|
| \| | +--ro output |

| | | |
|---|---|---|
| \| | +--ro status | enumeration |
| \| | +--ro error-message? | String |

Method 4: the selected beamforming-method may be configured to the O-RU through a new readable and writable parameter beamforming-method-configuration in the o-ran-delay-management.yang file. Examples are as follows:

+--rw delay-management
+--rw bandwidth-scs-delay-state* [bandwidth subcarrier-spacing]

| | | |
|---|---|---|
| \| | +--rw bandwidth | bandwidth |
| \| | +--rw subcarrier-spacing | uint32 |

| | |
|---|---|
| \| | +--rw beamforming-method-configuration* |

In operation S204, the O-RU may feed back whether the O-RU successfully adopts or fails to modify the beamforming method through O-FH. According to the updated beamforming method (for example, determined according to the information received in operation S203), the O-RU optimally selects the O-RU delay profile (for example, it may be the same as all or part of the content reported in operation S201) corresponding to beamforming in definition of the transmit and/or receive cache windows and the buffering operation at the receive end.

In an alternative implementation, the O-RU may also report second information related to delay management in operation 204, for example, the second information is related to the delay profile adopted by the O-RU.

In one example, the second information related to delay management reported in operation 204 includes but not limited to the beamforming method adopted by the O-RU. The O-RU may report the second information related to delay management by at least one of the following methods, so that the O-DU can acquire information related to the beamforming methods of the O-RU:

Method 1: the O-RU may newly add a beamforming type parameter beamforming-method-configuration into “low-level-tx/rx-endpoints” in the o-ran-uplane-conf.yang file to perform state reporting, so as to report the second information related to delay management. Examples are as follows:

+--rw low-level-tx-endpoints* [name]

| | | |
|---|---|---|
| \| | +--rw name | −> /user-plane-configuration/static- |

low-level-tx-endpoints/name

| | | |
|---|---|---|
| \| | +--rw sro-id? | −> /or-user:users/user/sro-id |

{feat:SHARED-O-RU-MULTI-OPERATOR}?

| \| | +--rw compression! | | |
|---|---|---|---|
| \| | \| | +--rw iq-bitwidth? | Uint8 |
| \| | \| | +--rw compression-type | compression-type-def |
| \| | \| | x-rw bitwidth? | Uint8 |
| \| | \| | +--rw compression-method? | Compression-method- |

| def | | |
|---|---|---|
| \| | \| | x-rw (compression-format)? |

| \| | +--rw frame-structure? | Uint8 |
|---|---|---|
| \| | +--rw cp-type? | Enumeration |
| \| | +--rw cp-length | uint16 |
| \| | +--rw cp-length-other | uint16 |
| \| | +--rw offset-to-absolute-frequency-center | int32 |
| \| | +--rw number-of-prb-per-scs* [scs] | |
| \| | +--rw e-axcid | |
| \| | +--rw coupling-to? | |
| \| | +--rw coupling-method? | Enumeration |
| \| | +--rw configurable-tdd-pattern-supported? | |
| \| | +--rw cplane-message-processing-limits-enabled? | |
| \| | +--rw uplane-message-section-header-limit-enabled? | |
| \| | +--rw beam-update-contention-control-enabled? | |
| \| | +--rw | channel-information-prb-group-configuration |

{feat:CHANNEL-INFORMATION-PRB-GROUP}?

| | | |
|---|---|---|
| \| | +--rw non-scheduled-ueid-enabled? | Boolean {feat:NON- |

SCHEDULED-UEID}?

| | |
|---|---|
| \| | +--rw se-11-continuity-flag-enabled? |
| \| | +--rw combination-configuration |

| \| | +--rw beamforming-method-configuration* | |
|---|---|---|
| \| | \| | +--rw beamforming-method? |

Method 2: if the O-DU configures the beamforming method to the O-RU by newly adding a remote procedure call model in the beamforming profile o-ran-beamforming.yang, the O-RU may report the second information related to delay management in this operation S204 by adding a read-only parameter beamforming-method in a notification in the o-ran-beamforming.yang. Examples are as follows:
notifications:

| | |
|---|---|
| | +---n beamforming-method-information-update |
| \| | +--ro band-number? −> /mcap:mO-Dule-capability/band- |

capabilities/band-number

| | |
|---|---|
| \| | +--ro beamforming-method* |

Method 3: reporting second information related to delay management may be performed by reporting the used beamforming method parameter in the o-ran-delay-management.yang file through the management plane. Examples are as follows:

+--rw delay-management

+--rw bandwidth-scs-delay-state* [bandwidth subcarrier-spacing]
| +--rw bandwidth bandwidth
| +--rw subcarrier-spacing uint32

| | |
|---|---|
| \| | +--ro beamforming-method |

Exception handling: if the O-RU fails to update the delay parameters, that is, the O-RU fails to successfully use or configure the delay profile related to the beamforming method configured by the O-DU in operation 203, the O-RU also carries the last saved or default beamforming method when giving feedback (for example, transmitting a beamforming method configuration response) through the O-FH.

According to the update fed back by the O-RU, the O-DU uses the delay parameters corresponding to the beamforming method fed back by the O-RU for delay management, such as calculating the corresponding delay and transmitting and/or receiving based on the calculated delay.

In operation 205, the O-DU updates the O-DU delay parameters according to the feedback of the O-RU. The O-DU adaptively calculates receive/transmit delays of the O-DU according to the delay profile updated by the O-RU, thus updating receive/transmit cache windows of the O-DU and improving the performance of O-DU scheduling resources.

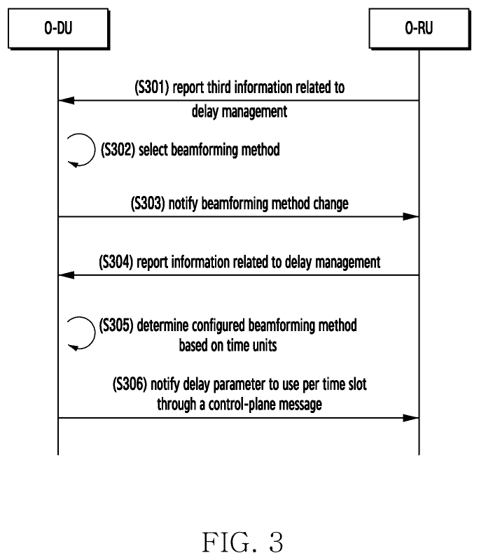

FIG. 3 illustrates a schematic diagram of an example of a management flow of dynamic updating of delay management (a management flow based on dynamic management of a delay profile) according to an embodiment of the disclosure.

Referring to FIG. 3, if an application scenario allows the O-DU delay profile to be dynamically changeable, dynamic configuration updating may be performed in a running process, and this dynamic change may be real-time and be performed based on time units, for example, based on time slot levels. This dynamic change may also be reconfigured through a management plane profile, and the reconfiguration at the endpoint level will not affect services in other endpoints in the O-RU. The method described in connection with FIG. 3 is only an example, and some operations may be omitted or some new operations may be added.

Referring to FIG. 3, the management flow of dynamic delay management according to some embodiments of the disclosure includes the following operations.

In operation S301, the O-RU reports third information related to delay management. The O-RU transmits the third information including a supported delay profile in uplink through the O-FH interface. For example, the third information may include: supported beamforming methods, such as at least one of a beamforming method based on channel information, a beamforming method with predefined beams, a dynamic beamforming method based on beam weights, and a dynamic beamforming method based on beam characteristics, as well as O-RU delay profiles corresponding to the beamforming methods. As another example, the third information may include variable channel conditions that can affect the change of the beamforming method. The beamforming method applied by each endpoint may be changed through variable channel conditions, and when the currently used O-RU delay profile cannot be used for the changed beamforming method, the changed beamforming method may lead to the reconfiguration of the O-RU delay profile. The variable channel conditions include but not limited to a current maximum number of data streams of the O-RU (O-RU capability), current channel quality (UE level), and current computing resource consumption of the O-RU and the O-DU;

The reported delay profile includes at least one delay parameter, including but not limited to 12a-min-up, t2a-max-up, t2a-min-cp-dl, t2a-max-cp-dl, tcp-adv-dl, ta3-min, ta3-max, t2a-min-cp-ul, t2a-max-cp-ul, or the like.

In an implementation, reporting the third information related to delay management includes reporting the capability of supporting dynamic configuration of delay parameters; the dynamic configuration of delay parameters may be indicated as one “feature” parameter, feature: dynamic-delay-per-beamforming-type; when the O-RU supports the dynamic configuration of delay parameters based on time slots, such indication information may be reported.

In operation S302, the O-DU selects the beamforming method according to an algorithm. A selection process is implemented internally. For example, the O-DU changes the beamforming method and the delay configuration parameters corresponding to the changed beamforming method according to the channel feedback information. In an implementation, the O-DU selects the beamforming method according to the delay profile reported by the O-RU in operation S301.

In an implementation, the O-DU selects the beamforming method according to the channel conditions in operation S301, because of the change of one or more factors as shown below. The three factors are listed as follows in order of priority: the current maximum number of data streams of the O-RU (O-RU capability), the current channel quality (UE level), and the current computing resource consumption of the O-RU and the O-DU. Furthermore, the priority order of these factors may also be other orders.

For example,
1) when the current maximum number of data streams of the O-RU is less than a defined threshold (for example, the transmission and reception channels are turned off to save energy), and the only beamforming mode that may be applied is a predefined beamforming mode regardless of the current channel quality and the consumption of node computing resources.
2) the current maximum number of data streams of the O-RU is greater than the threshold (for example, the transmission and reception channels is waken up from an energy-saving state), and the beamforming method of the O-DU will be updated with further consideration of channel quality and the consumption of node computing resources. If the current channel quality (UE level) is greater than the defined threshold and computing resources can be used for the beamforming weight, the beamforming mode may be updated. Otherwise, if the current channel quality (UE level) is less than the defined threshold, only the predefined beamforming mode can be applied. When the channel quality is low, the beamforming weight calculation is meaningless.

| BF mode change | Triggering condition |
|---|---|
| BF based on weights −> | Transmission and reception of antennas are |
| BF with predefined | turned off to save energy, resulting in that |
| beams | the current maximum number of data streams |
| | of the O-RU is less than or equal to the |
| | threshold. |

In operation S303, the O-DU notifies the O-RU of the dynamic configuration of delay parameters or the change of the beamforming method. The O-DU notifies the O-RU of the changed delay parameters or beamforming method through the O-FH interface. In the dynamic configuration of delay parameters or the dynamic beamforming method, multiple beamforming methods may be simultaneously configured to the O-RU through the management plane. Since the dynamic beamforming of each RU may be different based on different endpoints, each endpoint is configured with new delay parameters through the configuration with smaller granularity (for example, the endpoint is the smaller granularity compared with the entire O-RU).

After each endpoint updates the BF mode, there are two kind of content for O-DU reconfiguration messages, depending on whether the O-DU knows the transmission delay between the O-DU and the O-RU (transmission delay measurement is optional for the O-RU).

If the O-DU does not know the transmission delay, the O-DU reconfigures the O-RU delay profile through delay-profiles-id reported at startup.

If the O-DU knows the transmission delay, the O-DU reconfigures the O-RU delay profile through the suggested O-RU delay profile which is optimized by the O-DU considering the transmission delay parameters.

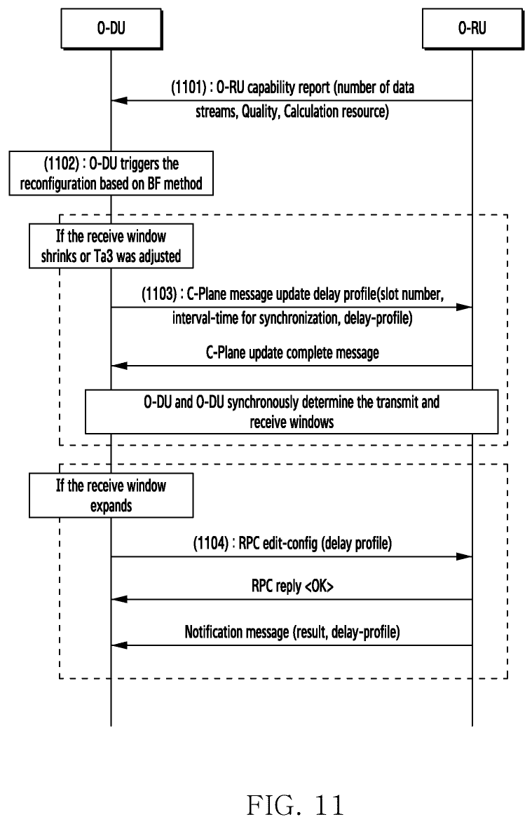

FIG. 11 illustrates a schematic diagram of a reconfiguration method for reconfiguring a delay profile to the O-RU by the O-DU according to an embodiment of the disclosure.

Referring to FIG. 11, regarding the reconfiguration method for reconfiguring the delay profile to the O-RU by the O-DU, a first optional reconfiguration process solution is shown, wherein:
Operation 1101: the O-RU transmits capability report (number of data streams, Quality, Calculation resource) to the O-DU;
Operation 1102: the O-DU triggers the reconfiguration based on BF method;
Operation 1103: a synchronous change of configuration is performed using a time interval, and the change is configured using a control plane. For example, the second node (the O-RU) transmits a first message related to updating of a delay profile to the first node (the O-DU), and an interval time parameter ΔT and a current slot number are added in the operation to implement the synchronous change of the configuration; and
Operation 1104: the O-DU transmits RPC edit-config (delay profile) to the O-RU.

ΔT (interval time) is specified by a time parameter in a control-plane reconfiguration message (for example, the first message), and a duration of the time slot is indicated in the control-plane common part type header in terms of the number of time slots greater than zero.

ΔT >control-plane message transmission delay time between the O-RU and the O-DU+maximum profile switching time (indicating maximum processing time for the O-RU to use a new transmit or receive window). For example, the maximum profile switching time may be reported by the O-RU together with information related to the delay profiles when reporting its capability of supporting multiple delay profiles based on the BF methods to O-DU.

The O-RU calculates a time slot for changing the delay profile according to the current time slot number and ΔT. Then the O-DU and the O-RU will perform updating simultaneously in the same time slot.

The O-RU may transmit a “Ready” message to the O-DU, which contains a specific “Ready” bit indicating that the O-RU is ready to handle the delay profile updating.

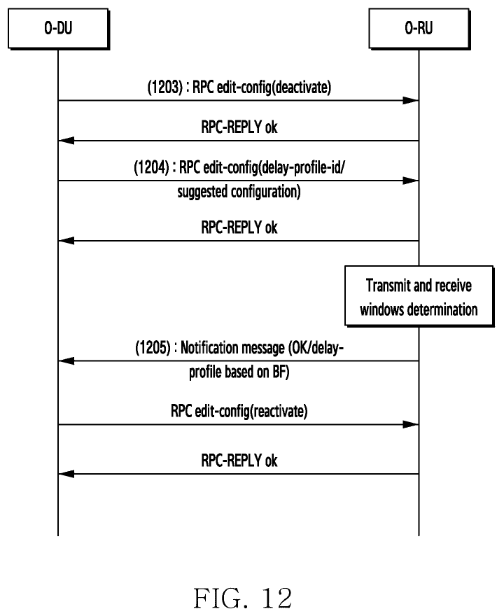

An optional reconfiguration solution 2 is shown in FIG. 12.

FIG. 12 illustrates a schematic diagram of another reconfiguration method for reconfiguring a delay profile to the O-RU by the O-DU according to an embodiment of the disclosure.

The delay profile per endpoint is updated using a process similar to that of the current management-plane configuration. In order to ensure the synchronization of delay configuration of the O-DU and the O-RU, since a management-plane command will be performed in an unknown time slot, the window timing of the O-DU and the O-RU is not guaranteed to be consistent.

Referring to FIG. 12, in operation 1203, the O-DU transmits configuration information including information about endpoints that need to deactivate carriers and make delay profile changes. For example, the second node (O-DU) transmits information related to updating of a delay profile to the first node (O-RU). For example, the O-DU may transmit a deactivation command and an updating command (including an updated delay profile, for example), the O-RU deactivates corresponding carriers (for example, a part of the carriers in the endpoint that need to change the delay profile) according to the deactivation command and updates the delay profiles on the corresponding endpoints. For example, it may be achieved by enhancing RPC to include a specific deactivation endpoint for which the updating of the delay profile is targeted. The updating of the delay profile is allowed to be performed per endpoint. In operation 1204: the O-DU configures new delay profiles to the endpoints of the O-RU. The O-RU may use the new delay profile of each endpoint to determine a transmit or receive window. In operation 305: the O-RU then activates the above-mentioned endpoints which are deactivated to make the delay profile change.

Considering the influence of the window, for example, when optimization parameters are T2a_min_up and T2a_max_up, the enlarging of the O-RU receive window, and the widening of the receive window do not cause a part of the message to be discarded. At this time, delay configuration synchronization between the O-DU and the O-RU are not required, and the updating can be directly reconfigured using the management-plane command, that is, operation 1204 is directly used.

In operation 1205: the O-RU feeds back the notification message (OK/delay-profile based on BF) to the O-DU.

Referring back to FIG. 3, in operation S304, the O-RU feeds back updating information. This operation is similar to operation 204, and will not be repeated here.

In operation S305, the O-DU dynamically determines the beamforming method configured for the O-RU based on time units (e.g., time slots).

In operation S306, the O-DU notifies the O-RU of the delay profile (including one or more delay parameters) used in each time slot through the control-plane messages at different time slots, which can be implemented as follows: in the control-plane or user-plane message, the O-RU is informed of the beamforming method adopted by the current message through different message types or indication. The O-RU selects the delay profile related to the beamforming method according to the indication of the message, or when multiple groups of beamforming methods are supported simultaneously, the O-RU can calculate and obtain the optimal delay profile to use currently through at least one group of delay profiles corresponding to the multiple groups of beamforming methods through a certain algorithm.

Through the above method, dynamic delay management based on time units may be implemented, so that delay management can be better adapted to a current communication environment.

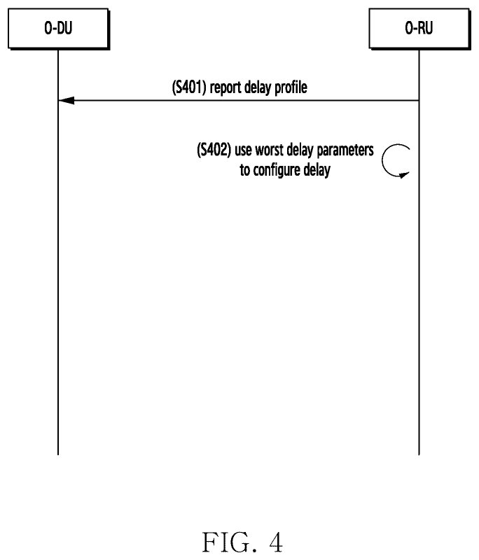

FIG. 4 illustrates a schematic diagram of an example of a management flow of delay management according to an embodiment of the disclosure.

Referring to FIG. 4, the management flow includes the following operations.

In operation S401, an O-RU reports fourth information related to delay management. The O-RU transmits the fourth information including a delay profile (including at least one delay parameter) in uplink through an O-FH interface. For example, the O-RU supports one group of O-RU delay parameters under all beamforming methods, and only one group of O-RU delay parameters may be reported when the O-RU supports multiple beamforming methods simultaneously. In an implementation, the determination of such delay parameters can consider all beamforming methods supported by the O-RU, and all beamforming methods are covered by setting a worst delay parameter. For example, for each of delay parameters to be reported, the worst delay parameter corresponding to all beamforming methods supported by the O-RU may be reported. For example, if the O-RU supports beamforming methods bf1, bf2 and bf3, and the delay parameters to be reported are delay0 and delay1; if delay0 corresponding to bf1 is the worst and delay1 corresponding to bf3 is the worst, the O-RU may report delay0 corresponding to bf1 and delay1 corresponding to bf3.

In operation S402, the O-RU continuously uses the worst delay parameter to configure the delay of the O-RU.

Through the above method, the delay parameters can be applied to all beamforming methods supported by the O-RU without modifying existing settings.

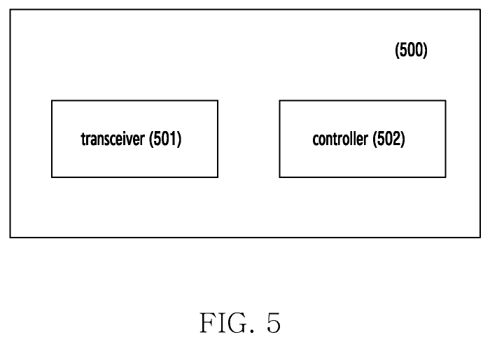

FIG. 5 illustrates a simple block diagram of a hardware structure of a first node according to an embodiment of the disclosure.

Referring to FIG. 5, a first node 500 may be used to implement any method performed by the O-RU according to the principles of the disclosure.

The first node 500 according to an embodiment of the disclosure includes a transceiver 501 and a controller 502. Optionally, the first node 500 may further include memory (not shown). The transceiver 501 may transmit signals or data or receive signals or data. The controller 502 may be coupled with the transceiver 501 and the memory, and control operations of the transceiver 501 and the memory. The memory has stored therein computer executable instructions which, when performed by the controller 502, cause at least one method corresponding to the above embodiments of the disclosure to be performed.

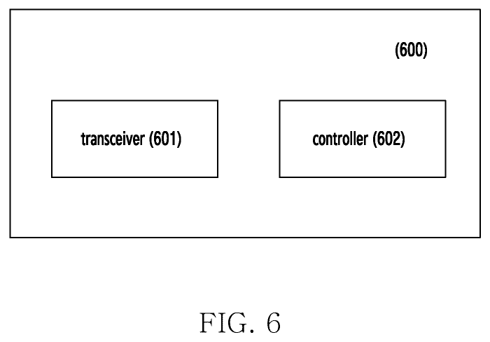

FIG. 6 illustrates a simple block diagram of a hardware structure of a second node according to an embodiment of the disclosure.

Referring to FIG. 6, a second node 600 shown in FIG. 6 may be used to implement any method performed by the O-DU according to the principles of the disclosure.

The second node 600 according to the embodiment of the disclosure includes a transceiver 601 and a controller 602. Optionally, the second node 600 may further include memory (not shown). The transceiver 601 may transmit signals or data or receive signals or data. The controller 602 may be coupled with the transceiver 601 and the memory, and control operations of the transceiver 601 and the memory. The memory has stored therein computer executable instructions which, when performed by the controller 602, cause at least one method corresponding to the above embodiments of the disclosure to be performed.

According to an embodiment, a method performed by a first node in a communication system, comprising transmitting a first delay information to a second node, wherein the first delay information is related to beamforming methods supported by the first node, receiving first configuration information related to delay management from the second node, and performing delay management based on the first configuration information.

According to an embodiment, the first delay information comprises information of at least one delay profile and each delay profile corresponds to one or more of the beamforming methods supported by the first node or no beamforming method. According to an embodiment, the information of the delay profile comprises information about the beamforming methods corresponding to the delay profile or relevant information indicating that the delay profile does not correspond to a beamforming method.

According to an embodiment, the first delay information comprises information of a delay profile supported by at least one endpoint of the first node, and the delay profile supported by the endpoint is associated with one or more beamforming methods supported by the endpoint or no beamforming method.

According to an embodiment, the information of the delay profile comprises a delay profile identification (ID).

According to an embodiment, the first delay information comprises information of a delay profile obtained based on delay information of the plurality of beamforming methods corresponding to the first node.

According to an embodiment, the first configuration information comprises information of the delay profile of at least one endpoint of the first node.

According to an embodiment, the information of the delay profile of the at least one endpoint of the first node comprises the delay profile ID corresponding to the at least one endpoint.

According to an embodiment, in a case that the first configuration information does not comprise the information of delay profile, the first node performs delay management according to a preset delay profile.

According to an embodiment, the method comprises transmitting information related to the beamforming methods to the second node, wherein the information related to the beamforming methods, comprises at least one of computing resource consumption of the first node, channel quality, and a maximum number of data streams of the first node.

According to an embodiment, the method comprises receiving a first message related to updating of the delay profile from the second node, wherein the first message comprises transmitting slot information of the first message, time interval information and the information of the delay profile, determining time for switching the delay profile based on the transmitting slot information and the time interval information, and upon reaching the determined time for switching the delay profile, updating the delay profile of the corresponding endpoint based on the information of the delay profile.

According to an embodiment, the method comprises transmitting, by the first node, maximum delay profile switching time information to the second node. According to an embodiment, the time interval information is determined based on the maximum delay profile switching time.

According to an embodiment, a method performed by a second node in a communication system, comprises receiving a first delay information from a first node, wherein the first delay information is related to beamforming methods supported by the first node, and transmitting first configuration information related to delay management to the first node.

According to an embodiment, the method comprises transmitting a first message related to updating of a delay profile to the first node. According to an embodiment, the first message comprises transmitting slot information of the first message, time interval information, and information of the delay profile.

According to an embodiment, before transmitting a first message related to updating of a delay profile to the first node, the method further comprises determining that a receive window of the first node becomes smaller after the delay profile is updated or a data processing delay of the first node changes after the delay profile is updated.

According to an embodiment, the method comprises receiving maximum delay profile switching time information from the first node, and determining the time interval information based on the maximum delay profile switching time.

According to an embodiment, the method comprises transmitting a second message related to updating of the delay profile to the first node, wherein the second message comprises information of the updated delay profile of at least one endpoint.

According to an embodiment, before transmitting a second message related to updating of a delay profile to the first node, the method comprises determining that the receive window of the first node becomes larger after the delay profile is updated.

According to an embodiment, a first node in a communication system, comprises a transceiver configured to transmit and/or receive signals, memory storing one or more computer programs, and one or more processors comprising processing circuitry. According to an embodiment, the one or more computer programs include computer-executable instructions that, when executed by the one or more processors, cause the first node to transmit a first delay information to a second node, wherein the first delay information is related to beamforming methods supported by the first node, receive first configuration information related to delay management from the second node, and perform delay management based on the first configuration information.

According to an embodiment, the first delay information comprises information of at least one delay profile. According to an embodiment, each delay profile corresponds to one or more of the beamforming methods supported by the first node or no beamforming method. According to an embodiment, the information of the delay profile comprises information about the beamforming methods corresponding to the delay profile or relevant information indicating that the delay profile does not correspond to a beamforming method.

According to an embodiment, a second node in a communication system, comprises a transceiver configured to transmit and/or receive signals, memory storing one or more computer programs, and one or more processors comprising processing circuitry. According to an embodiment, the one or more computer programs include computer-executable instructions that, when executed by the one or more processors, cause the second node to transmit a first delay information to a second node, wherein the first delay information is related to beamforming methods supported by the second node, receive first configuration information related to delay management from the second node, and perform delay management based on the first configuration information.

According to an embodiment, a method performed by a first node in a communication system, comprises reporting a first delay parameter to a second node, wherein the first delay parameter is related to beamforming methods supported by the first node, receiving first configuration information related to delay management from the second node, and performing delay management based on the first configuration information.

According to an embodiment, a method performed by a second node in a communication system, comprises receiving a first delay parameter from a first node, wherein the first delay parameter is related to beamforming methods supported by the first node, and transmitting first configuration information related to delay management to the first node.

According to an embodiment, a method performed by a radio unit (RU) in a communication system, comprises transmitting, to a digital unit (DU), first delay profile information for a first antenna of the RU, information on a first beamforming scheme used for the first antenna, second delay profile information for a second antenna of the RU, and information on a second beamforming scheme used for the second antenna, receiving, from the DU, information on a first reception window associated with the first delay profile information, and information on a second reception window associated with the second delay profile information, based on identifying that a first control message is received within the first reception window, transmitting, through the first antenna, first data related to the first control message in accordance with the first beamforming scheme, and based on identifying that a second control message is received within the second reception window, transmitting, through the second antenna, second data related to the second control message in accordance with the second beamforming scheme.

For example, each of the first beamforming scheme and the second beamforming scheme comprises at least one of a weight-based dynamic beamforming scheme, a predefined beamforming scheme, an attribute-based dynamic beamforming scheme, or channel information-based beamforming scheme.

For example, the method comprises, based on identifying that the first beamforming scheme for the first antenna is changed, transmitting capability information of the first antenna to the DU, and in response to transmitting the capability information of the first antenna to the DU, receiving a first message used for changing the first reception window to a third reception window longer than the first reception window.

For example, the method comprises, based on identifying that the first beamforming scheme for the first antenna is changed, transmitting capability information of the first antenna to the DU, and in response to transmitting the capability information of the first antenna to the DU, receiving a second message used for changing the first reception window to a fourth reception window shorter than the first reception window.

For example, the method comprises updating, based on the second message, the first delay profile information for changing the first reception window to the fourth reception window.

According to an embodiment, a method performed by a digital unit (DU) in a communication system, comprises receiving, from a radio unit (RU), first delay profile information for a first antenna of the RU, information on a first beamforming scheme used for the first antenna, second delay profile information for a second antenna of the RU, and information on a second beamforming scheme used for the second antenna, determining, based on the first delay profile information and the information on the first beamforming scheme, a first reception window, determining, based on the second delay profile information and the information on the second beamforming scheme, a second reception window, and transmitting, to the RU, information on the first reception window and information on the second reception window.

For example, each of the first beamforming scheme and the second beamforming scheme comprises at least one of a weight-based dynamic beamforming scheme, a predefined beamforming scheme, an attribute-based dynamic beamforming scheme, or channel information-based beamforming scheme.

For example, the method comprises receiving capability information of the first antenna from the RU, and based on the capability information of the first antenna, transmitting a first message used for changing the first reception window to a third reception window longer than the first reception window.

For example, the method comprises receiving capability information of the first antenna from the RU, and based on the capability information of the first antenna, transmitting a second message used for changing the first reception window to a fourth reception window shorter than the first reception window.

For example, the second message is configured to cause the RU to update the first delay profile information for changing the first reception window to the fourth reception window.

According to an embodiment, a radio unit (RU) comprises a plurality of antennas including a first antenna and a second antenna, communication circuitry, memory comprising one or more storage media, storing instructions, and at least one processor comprising processing circuitry. The instructions, when executed by the at least one processor individually or collectively, cause the RU to transmit, via the communication circuitry, to a digital unit (DU), first delay profile information for the first antenna of the RU, information on a first beamforming scheme used for the first antenna, second delay profile information for the second antenna of the RU, and information on a second beamforming scheme used for the second antenna, receive, via the communication circuitry, from the DU, information on a first reception window associated with the first delay profile information, and information on a second reception window associated with the second delay profile information, based on identifying that a first control message is received within the first reception window, transmit, through the first antenna, first data related to the first control message in accordance with the first beamforming scheme, and based on identifying that a second control message is received within the second reception window, transmit, through the second antenna, second data related to the second control message in accordance with the second beamforming scheme.

For example, each of the first beamforming scheme and the second beamforming scheme comprises at least one of a weight-based dynamic beamforming scheme, a predefined beamforming scheme, an attribute-based dynamic beamforming scheme, or channel information-based beamforming scheme.

For example, the instructions, when executed by the at least one processor individually or collectively, cause the RU to, based on identifying that the first beamforming method for the first antenna is changed, transmit capability information of the first antenna to the DU, and in response to transmitting the capability information of the first antenna to the DU, receive a first message used for changing the first reception window to a third reception window longer than the first reception window.

For example, the instructions, when executed by the at least one processor individually or collectively, cause the RU to, based on identifying that the first beamforming scheme for the first antenna is changed, transmit capability information of the first antenna to the DU, and in response to transmitting the capability information of the first antenna to the DU, receive a second message used for changing the first reception window to a fourth reception window shorter than the first reception window.

For example, the instructions, when executed by the at least one processor individually or collectively, cause the RU to update, based on the second message, the first delay profile information for changing the first reception window to the fourth reception window.

According to an embodiment, a digital unit (DU) comprises communication circuitry, memory comprising one or more storage media, storing instructions, and at least one processor comprising processing circuitry. The instructions, when executed by the at least one processor individually or collectively, cause the DU to receive, via the communication circuitry, from a radio unit (RU), first delay profile information for a first antenna of the RU, information on a first beamforming scheme used for the first antenna, second delay profile information for a second antenna of the RU, and information on a second beamforming scheme used for the second antenna, determine, based on the first delay profile information and the information on the first beamforming scheme, a first reception window, determining, based on the second delay profile information and the information on the second beamforming scheme, a second reception window, and transmit, via the communication circuitry, to the RU, information on the first reception window, and information on the second reception window.

For example, each of the first beamforming scheme and the second beamforming scheme comprises at least one of a weight-based dynamic beamforming scheme, a predefined beamforming scheme, an attribute-based dynamic beamforming scheme, or channel information-based beamforming scheme.

For example, the instructions, when executed by the at least one processor individually or collectively, cause the DU to receive capability information of the first antenna from the RU, and based on the capability information of the first antenna, transmit a first message used for changing the first reception window to a third reception window longer than the first reception window.

For example, the instructions, when executed by the at least one processor individually or collectively, cause the DU to receive capability information of the first antenna from the RU, and based on the capability information of the first antenna, transmit a second message used for changing the first reception window to a fourth reception window shorter than the first reception window.

For example, the second message is configured to cause the RU to update the first delay profile information for changing the first reception window to the fourth reception window.

The embodiments described above are only embodiments of the disclosure and should not be taken as limiting the scope of the disclosure. Any modifications, equivalents, improvements and the like made within the spirit and principle of the disclosure should be included in the scope of protection of the disclosure.

It can be understood by those skilled in the art that the application may include devices for performing one or more of the operations described in the application. These devices may be specially designed and manufactured for required purposes, or may also include known devices in general-purpose computers. These devices have computer programs stored therein, which are selectively activated or reconfigured. Such computer programs may be stored in a device (e.g., a computer) readable medium or in any type of medium suitable for storing electronic instructions and coupled to a bus, and the computer readable medium includes but not limited to any type of disks (including a floppy disk, a hard disk, an optical disk, a CD-ROM, and a magneto-optical disk), read-only memory (ROM), random access memory (RAM), erasable programmable read-only memory (EPROM), electrically erasable programmable read-only memory (EEPROM), flash memory, a magnetic card or an optical card. For example, a readable medium includes any medium in which information is stored or transmitted by a device (e.g., a computer) in a readable form.

It can be understood by those skilled in the art that each block in these structural diagrams and/or block diagrams and/or flow diagrams and combinations of blocks in these structural diagrams and/or block diagrams and/or flow diagrams can be implemented by computer program instructions. It can be understood by those skilled in the art that these computer program instructions may be provided to a processor of a general-purpose computer, a professional computer or other programmable data processing methods for implementation, so that the solutions specified in the block or blocks of the structural diagrams and/or block diagrams and/or flow diagrams disclosed in the disclosure may be performed by the processor of the computer or other programmable data processing methods.

Those skilled in the art will appreciate that operations, measures and solutions in various operations, methods and processes already discussed in the disclosure, may be alternated, modified, combined, or deleted. Further, other operations, measures and solutions in the various operations, methods and processes already discussed in the disclosure may also be alternated, modified, rearranged, decomposed, combined or deleted. Further, operations, measures and solutions in the various operations, methods and processes disclosed in the disclosure and in the prior art can also be alternated, modified, rearranged, decomposed, combined or deleted.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a radio unit (RU) in a communication system, the method comprising:
transmitting, to a digital unit (DU), first delay profile information for a first antenna of the RU, information on a first beamforming scheme used for the first antenna, second delay profile information for a second antenna of the RU, and information on a second beamforming scheme used for the second antenna,
receiving, from the DU, information on a first reception window associated with the first delay profile information, and information on a second reception window associated with the second delay profile information,
based on identifying that a first control message is received within the first reception window, transmitting, through the first antenna, first data related to the first control message in accordance with the first beamforming scheme, and
based on identifying that a second control message is received within the second reception window, transmitting, through the second antenna, second data related to the second control message in accordance with the second beamforming scheme.

2. The method of claim 1, wherein each of the first beamforming scheme and the second beamforming scheme comprises at least one of a weight-based dynamic beamforming scheme, a predefined beamforming scheme, an attribute-based dynamic beamforming scheme, or channel information-based beamforming scheme.

3. The method of claim 1, wherein the method comprises:
based on identifying that the first beamforming scheme for the first antenna is changed, transmitting capability information of the first antenna to the DU, and
in response to transmitting the capability information of the first antenna to the DU, receiving a first message used for changing the first reception window to a third reception window longer than the first reception window.

4. The method of claim 1, wherein the method comprises:
based on identifying that the first beamforming scheme for the first antenna is changed, transmitting capability information of the first antenna to the DU, and
in response to transmitting the capability information of the first antenna to the DU, receiving a second message used for changing the first reception window to a fourth reception window shorter than the first reception window.

5. The method of claim 4, wherein the method comprises updating, based on the second message, the first delay profile information for changing the first reception window to the fourth reception window.

6. A method performed by a digital unit (DU) in a communication system, the method comprising:
receiving, from a radio unit (RU), first delay profile information for a first antenna of the RU, information on a first beamforming scheme used for the first antenna, second delay profile information for a second antenna of the RU, and information on a second beamforming scheme used for the second antenna,
determining, based on the first delay profile information and the information on the first beamforming scheme, a first reception window,
determining, based on the second delay profile information and the information on the second beamforming scheme, a second reception window, and
transmitting, to the RU, information on the first reception window and information on the second reception window.

7. The method of claim 6, wherein each of the first beamforming scheme and the second beamforming scheme comprises at least one of a weight-based dynamic beamforming scheme, a predefined beamforming scheme, an attribute-based dynamic beamforming scheme, or channel information-based beamforming scheme.

8. The method of claim 6, wherein the method comprises:
receiving capability information of the first antenna from the RU, and
based on the capability information of the first antenna, transmitting a first message used for changing the first reception window to a third reception window longer than the first reception window.

9. The method of claim 6, wherein the method comprises:
receiving capability information of the first antenna from the RU, and
based on the capability information of the first antenna, transmitting a second message used for changing the first reception window to a fourth reception window shorter than the first reception window.

10. The method of claim 9, wherein the second message is configured to cause the RU to update the first delay profile information for changing the first reception window to the fourth reception window.

11. A radio unit (RU) comprising:
a plurality of antennas including a first antenna and a second antenna;
communication circuitry;
memory comprising one or more storage media, storing instructions; and
at least one processor comprising processing circuitry,
wherein the instructions, when executed by the at least one processor individually or collectively, cause the RU to:
transmit, via the communication circuitry, to a digital unit (DU), first delay profile information for the first antenna of the RU, information on a first beamforming scheme used for the first antenna, second delay profile information for the second antenna of the RU, and information on a second beamforming scheme used for the second antenna,
receive, via the communication circuitry, from the DU, information on a first reception window associated with the first delay profile information, and information on a second reception window associated with the second delay profile information,
based on identifying that a first control message is received within the first reception window, transmit, through the first antenna, first data related to the first control message in accordance with the first beamforming scheme, and
based on identifying that a second control message is received within the second reception window, transmit, through the second antenna, second data related to the second control message in accordance with the second beamforming scheme.

12. The RU of claim 11, wherein each of the first beamforming scheme and the second beamforming scheme comprises at least one of a weight-based dynamic beamforming scheme, a predefined beamforming scheme, an attribute-based dynamic beamforming scheme, or channel information-based beamforming scheme.

13. The RU of claim 11, wherein the instructions, when executed by the at least one processor individually or collectively, cause the RU to:
based on identifying that the first beamforming method for the first antenna is changed, transmit capability information of the first antenna to the DU, and
in response to transmitting the capability information of the first antenna to the DU, receive a first message used for changing the first reception window to a third reception window longer than the first reception window.

14. The RU of claim 11, wherein the instructions, when executed by the at least one processor individually or collectively, cause the RU to:
based on identifying that the first beamforming scheme for the first antenna is changed, transmit capability information of the first antenna to the DU, and
in response to transmitting the capability information of the first antenna to the DU, receive a second message used for changing the first reception window to a fourth reception window shorter than the first reception window.

15. The RU of claim 14, wherein the instructions, when executed by the at least one processor individually or collectively, cause the RU to update, based on the second message, the first delay profile information for changing the first reception window to the fourth reception window.

16. A digital unit (DU) comprising:
communication circuitry;
memory comprising one or more storage media, storing instructions; and
at least one processor comprising processing circuitry,
wherein the instructions, when executed by the at least one processor individually or collectively, cause the DU to:
receive, via the communication circuitry, from a radio unit (RU), first delay profile information for a first antenna of the RU, information on a first beamforming scheme used for the first antenna, second delay profile information for a second antenna of the RU, and information on a second beamforming scheme used for the second antenna,
determine, based on the first delay profile information and the information on the first beamforming scheme, a first reception window,
determining, based on the second delay profile information and the information on the second beamforming scheme, a second reception window, and
transmit, via the communication circuitry, to the RU, information on the first reception window, and information on the second reception window.

17. The DU of claim 16, wherein each of the first beamforming scheme and the second beamforming scheme comprises at least one of a weight-based dynamic beamforming scheme, a predefined beamforming scheme, an attribute-based dynamic beamforming scheme, or channel information-based beamforming scheme.

18. The DU of claim 16, wherein the instructions, when executed by the at least one processor individually or collectively, cause the DU to:
receive capability information of the first antenna from the RU, and
based on the capability information of the first antenna, transmit a first message used for changing the first reception window to a third reception window longer than the first reception window.

19. The DU of claim 16, wherein the instructions, when executed by the at least one processor individually or collectively, cause the DU to:
receive capability information of the first antenna from the RU, and
based on the capability information of the first antenna, transmit a second message used for changing the first reception window to a fourth reception window shorter than the first reception window.

20. The DU of claim 19, wherein the second message is configured to cause the RU to update the first delay profile information for changing the first reception window to the fourth reception window.
